(19) United States
(12) Patent Application Publication
(10) Pub. No.: US 2026/0245792 A1
(43) Pub. Date: Aug. 20, 2026

(54) MULTILAYER CERAMIC ELECTRONIC COMPONENT

(71) Applicant: Murata Manufacturing Co., Ltd., Nagaokakyo-shi (JP)

(72) Inventor: Yukie WATANABE, Nagaokakyo-shi (JP)

(21) Appl. No.: 19/645,546

(22) Filed: Apr. 13, 2026

Related U.S. Application Data
(63) Continuation of application No. PCT/JP2024/044427, filed on Dec. 16, 2024.

(30) Foreign Application Priority Data
Feb. 13, 2024 (JP) 2024-019256

(51) Int. Cl. H01G 2/06; H01G 4/30

(52) U.S. Cl. CPC H01G 2/065; H01G 4/30

(57) ABSTRACT

A multilayer ceramic electronic component includes a multilayer body including dielectric layers, a first outer electrode located at least on a first end surface and a second main surface of the multilayer body, and a second outer electrode located at least on a second end surface and the second main surface of the multilayer body, and a bump on a surface of the first outer electrode and a surface of the second outer electrode at or adjacent to the second main surface of the multilayer body, and about 0.5<t1/t2<about 0.75 is satisfied, where t1 is a thickness of the bump in a height direction, and t2 is a thickness of the multilayer body in the height direction.

### CROSS REFERENCE TO RELATED APPLICATIONS

This application claims the benefit of priority to Japanese Patent Application No. 2024-019256 filed on Feb. 13, 2024 and is a Continuation Application of PCT Application No. PCT/JP2024/044427 filed on Dec. 16, 2024. The entire contents of each application are hereby incorporated herein by reference.

### BACKGROUND OF THE INVENTION

### 1. Field of the Invention

The present invention relates to multilayer ceramic electronic components.

### 2. Description of the Related Art

In recent years, electronic devices such as cellular phones and portable music players have become smaller and thinner. Along with this, multilayer ceramic electronic components that are included in small and thin electronic devices have become smaller and thinner.

As disclosed in, for example, Japanese Unexamined Patent Application Publication No. 2014-183186, a multilayer ceramic capacitor that is such a multilayer ceramic electronic component includes a dielectric chip in which dielectric ceramic such as barium titanate and inner electrodes are stacked in turn, and outer electrodes that cover end portions of the dielectric chip in a length direction (see Japanese Unexamined Patent Application Publication No. 2014-183186). For example, the multilayer ceramic capacitor disclosed in Japanese Unexamined Patent Application Publication No. 2014-183186 is a low-height multilayer ceramic capacitor that has a dimension of 150 μm or less in a height direction. Such a multilayer ceramic capacitor is mounted on a substrate by using a mounter.

### SUMMARY OF THE INVENTION

When a low-height multilayer ceramic capacitor is mounted on a mounting substrate by using a mounter nozzle, however, there is a possibility that the multilayer body of the multilayer ceramic capacitor cracks due to an impact during mounting and that insulation failure, for example, occurs.

For this reason, example embodiments of the present invention provide multilayer ceramic electronic components that each reduce or prevent stress concentrated on a multilayer body during mounting and that prevent the multilayer body from cracking.

A multilayer ceramic electronic component according to an example embodiment of the present invention includes a multilayer ceramic capacitor including a multilayer body including multiple stacked dielectric layers, a first main surface and a second main surface facing away from each other in a height direction, a first side surface and a second side surface facing away from each other in a width direction perpendicular to the height direction, and a first end surface and a second end surface facing away from each other in a length direction perpendicular to the height direction and the width direction, a first outer electrode that is located at least on the first end surface and the second main surface of the multilayer body, and a second outer electrode that is located at least on the second end surface and the second main surface of the multilayer body, and a bump located on a surface of the first outer electrode and a surface of the second outer electrode at or adjacent to the second main surface of the multilayer body, and a condition of about 0.5<t1/t2<about 0.75 is satisfied, where t1 is a thickness of the bump in the height direction, and t2 is a thickness of the multilayer body in the height direction.

A multilayer ceramic electronic component according to an example embodiment of the present invention includes the bump that is located on the surface of the first outer electrode and the surface of the second outer electrode at or adjacent to the second main surface of the multilayer body, and the condition of about 0.5<t1/t2<about 0.75 is satisfied, where t1 is the thickness of the bump in the height direction, and t2 is the thickness of the multilayer body in the height direction. Accordingly, an impact on the multilayer ceramic electronic component due to a mounter nozzle is transmitted to the bump particularly when the multilayer ceramic electronic component that is thin is mounted on a mounting substrate. This enables the multilayer body to be prevented from being damaged due to stress caused by the impact and concentrated on an edge portion of an outer electrode that is located at or adjacent to a main surface of the multilayer ceramic capacitor.

Example embodiments of the present invention provide multilayer ceramic electronic components that each reduce or prevent stress from being concentrated on a multilayer body during mounting and prevent the multilayer body from cracking.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 illustrates a perspective view of an example of a multilayer ceramic electronic component according to a first example embodiment of the present invention.

FIG. 2 illustrates a right-hand side view of an example of the multilayer ceramic electronic component according to the first example embodiment of the present invention.

FIG. 3 illustrates a front view of an example of the multilayer ceramic electronic component according to the first example embodiment of the present invention.

FIG. 4 illustrates a bottom view of an example of the multilayer ceramic electronic component according to the first example embodiment of the present invention.

FIG. 5 illustrates a sectional view taken along line V-V in FIG. 1.

FIG. 6 illustrates a sectional view taken along line VI-VI in FIG. 1.

FIG. 7 illustrates a sectional view taken along line VII-VII in FIG. 1.

FIG. 8 illustrates a perspective view of an example of a multilayer ceramic electronic component according to a first modification to the first example embodiment of the present invention.

FIG. 9 illustrates a right-hand side view of an example of the multilayer ceramic electronic component according to the first modification to the first example embodiment of the present invention.

FIG. 10 illustrates a front view of an example of the multilayer ceramic electronic component according to the first modification to the first example embodiment of the present invention.

FIG. 11 illustrates a bottom view of a multilayer ceramic capacitor that is an example of the multilayer ceramic electronic component according to the first modification to the first example embodiment of the present invention.

FIG. 12 illustrates a sectional view taken along line XII-XII in FIG. 8.

FIG. 13 illustrates a sectional view taken along line XIII-XIII in FIG. 8.

FIG. 14 illustrates a sectional view taken along line XIV-XIV in FIG. 8.

FIG. 15 illustrates a perspective view of an example of a multilayer ceramic electronic component according to a second modification to the first example embodiment of the present invention.

FIG. 16 illustrates a right-hand side view of an example of the multilayer ceramic electronic component according to the second modification to the first example embodiment of the present invention.

FIG. 17 illustrates a front view of an example of the multilayer ceramic electronic component according to the second modification to the first example embodiment of the present invention.

FIG. 18 illustrates a bottom view of a multilayer ceramic capacitor that is an example of the multilayer ceramic electronic component according to the second modification to the first example embodiment of the present invention.

FIG. 19 illustrates a sectional view taken along line XIX-XIX in FIG. 15.

FIG. 20 illustrates a sectional view taken along line XX-XX in FIG. 15.

FIG. 21 illustrates a sectional view taken along line XXI-XXI in FIG. 15.

FIG. 22 illustrates a perspective view of an example of a multilayer ceramic electronic component according to a third modification to the first example embodiment of the present invention.

FIG. 23 illustrates a right-hand side view of an example of the multilayer ceramic electronic component according to the third modification to the first example embodiment of the present invention.

FIG. 24 illustrates a front view of an example of the multilayer ceramic electronic component according to the third modification to the first example embodiment of the present invention.

FIG. 25 illustrates a bottom view of a multilayer ceramic capacitor that is an example of the multilayer ceramic electronic component according to the third modification to the first example embodiment of the present invention.

FIG. 26 illustrates a sectional view taken along line XXVI-XXVI in FIG. 22.

FIG. 27 illustrates a state in which the multilayer ceramic electronic component according to the first example embodiment of the present invention is mounted on a mounting substrate.

FIG. 28 illustrates a perspective view of an example of a multilayer ceramic electronic component according to a second example embodiment of the present invention.

FIG. 29 illustrates a front view of an example of the multilayer ceramic electronic component according to the second example embodiment of the present invention.

FIG. 30 illustrates a bottom view of an example of the multilayer ceramic electronic component according to the second example embodiment of the present invention.

FIG. 31 illustrates a sectional view taken along line XXXI-XXXI in FIG. 28.

FIG. 32 illustrates a sectional view taken along line XXXII-XXXII in FIG. 28.

FIG. 33 illustrates a sectional view taken along line XXXIII-XXXIII in FIG. 28.

FIG. 34 illustrates an exploded perspective view of a multilayer body illustrated in FIG. 28.

FIG. 35 illustrates a perspective view of an example of a multilayer ceramic electronic component according to a first modification to the second example embodiment of the present invention.

FIG. 36 illustrates a front view of an example of a multilayer ceramic electronic component according to a modification to the second example embodiment of the present invention.

FIG. 37 illustrates a bottom view of a multilayer ceramic capacitor that is an example of the multilayer ceramic electronic component according to a modification to the second example embodiment of the present invention.

FIG. 38 illustrates a sectional view taken along line XXXVIII-XXXVIII in FIG. 35.

FIG. 39 illustrates a sectional view taken along line XXXIX-XXXIX in FIG. 35.

### DETAILED DESCRIPTION OF THE EXAMPLE EMBODIMENTS

Examples of multilayer ceramic electronic components according to example embodiments of the present invention will now be described.

An example of a multilayer ceramic electronic component 10 according to an example embodiment of the present invention will be described. According to the present example embodiment, the multilayer ceramic electronic component 10 includes a multilayer ceramic capacitor 10A and bumps 40.

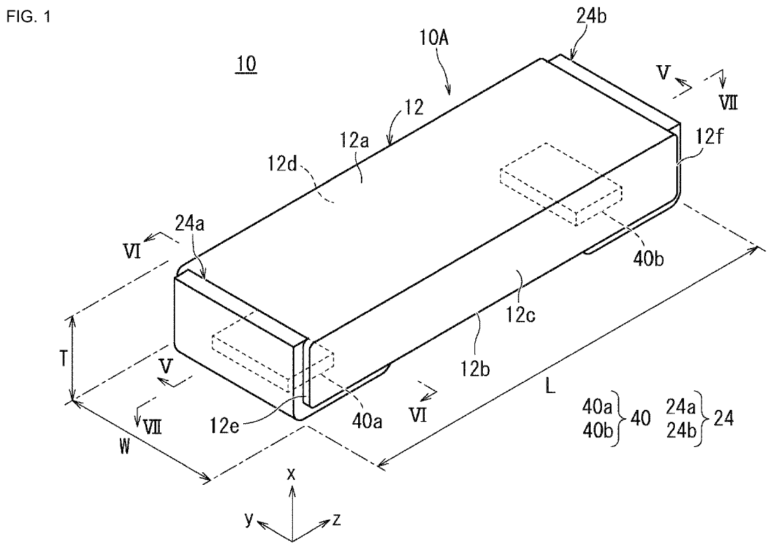

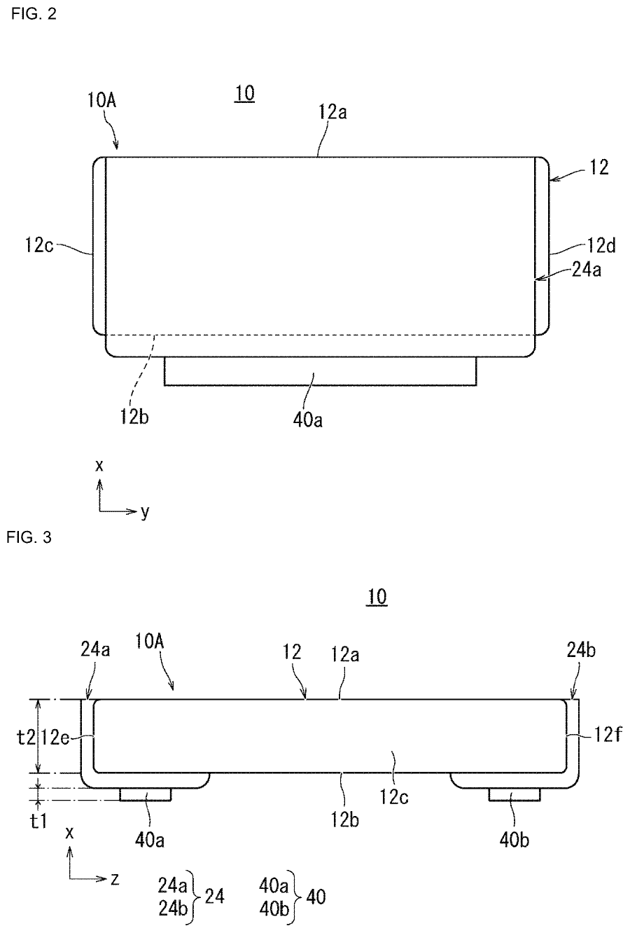

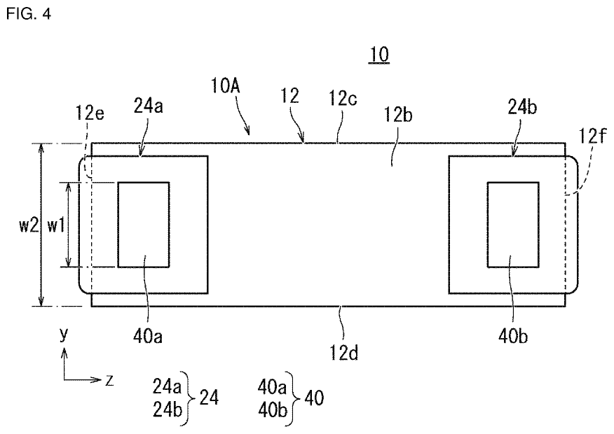

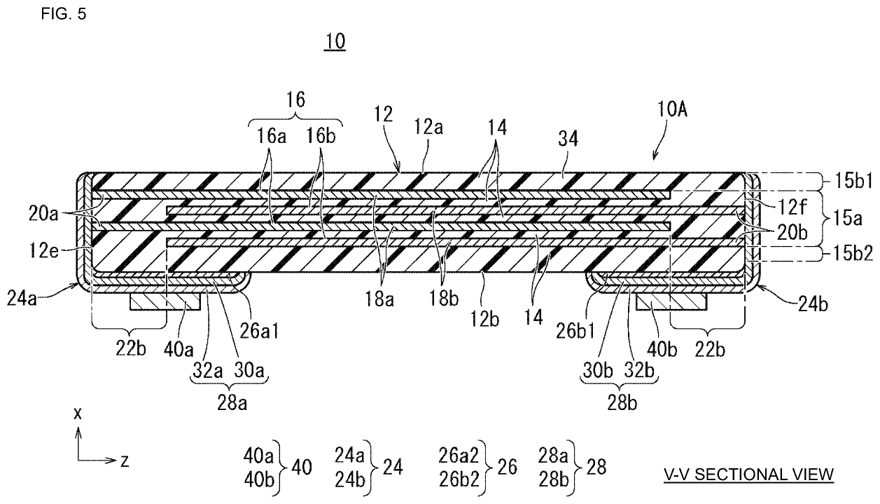

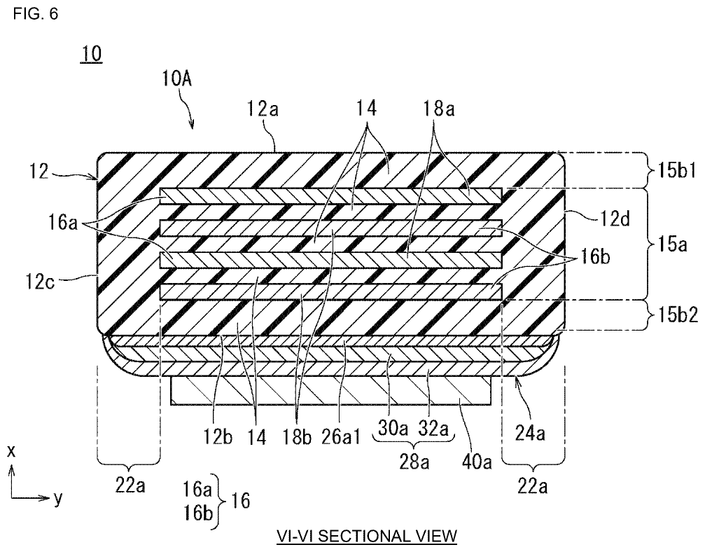

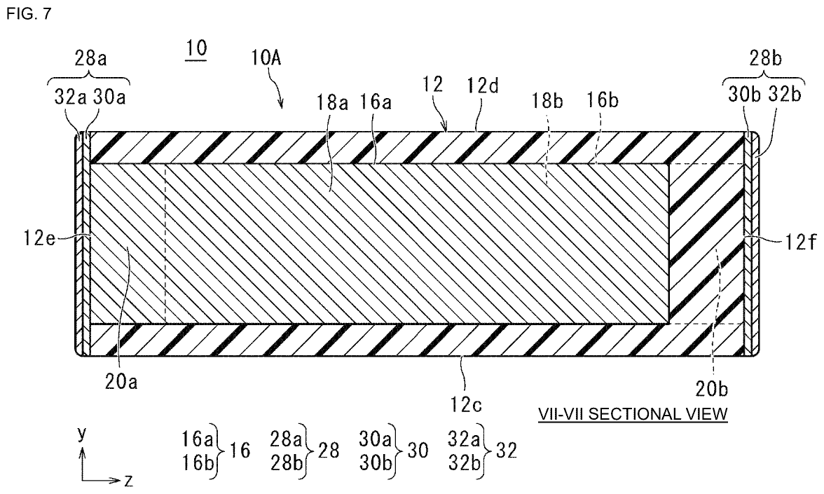

FIG. 1 illustrates a perspective view of an example of a multilayer ceramic electronic component according to the first example embodiment of the present invention. FIG. 2 illustrates a right-hand side view of an example of the multilayer ceramic electronic component according to the first example embodiment of the present invention. FIG. 3 illustrates a front view of an example of the multilayer ceramic electronic component according to the first example embodiment of the present invention. FIG. 4 illustrates a bottom view of an example of the multilayer ceramic electronic component according to the first example embodiment of the present invention. FIG. 5 illustrates a sectional view taken along line V-V in FIG. 1. FIG. 6 illustrates a sectional view taken along line VI-VI in FIG. 1. FIG. 7 illustrates a sectional view taken along line VII-VII in FIG. 1.

The multilayer ceramic capacitor 10A includes a multilayer body 12 and outer electrodes 24. Components will be described below in the order of the multilayer body 12 and the outer electrodes 24.

The multilayer body 12 includes multiple stacked dielectric layers 14 and multiple inner electrode layers 16. The multilayer body 12 includes a first main surface 12a and a second main surface 12b that face away from each other in a height direction x, a first side surface 12c and a second side surface 12d that face away from each other in a width direction y perpendicular to the height direction x, and a first end surface 12e and a second end surface 12f that face away from each other in a length direction z perpendicular to the height direction x and the width direction y. Corner portions and ridge portions of the multilayer body 12 are rounded. The corner portions are portions at which three adjacent surfaces of the multilayer body 12 intersect with each other, and the ridge portions are portions at which two adjacent surfaces of the multilayer body 12 intersect with each other. The first main surface 12a, the second main surface 12b, the first side surface 12c, the second side surface 12d, the first end surface 12e, and the second end surface 12f may be partly or entirely uneven.

As illustrated in FIG. 5, the multilayer body 12 includes an effective layer portion 15a at which the multiple inner electrode layers 16 face each other in the height direction x extending between the first main surface 12a and the second main surface 12b, a first outer layer portion 15b1 that includes multiple dielectric layers 14 that are located between the inner electrode layer 16 nearest to the first main surface 12a and the first main surface 12a, and a second outer layer portion 15b2 that includes multiple dielectric layers 14 that are located between the inner electrode layer 16 nearest to the second main surface 12b and the second main surface 12b.

The first outer layer portion 15b1 is located near the first main surface 12a of the multilayer body 12 and is an aggregate of multiple dielectric layers 14 located between the first main surface 12a and the inner electrode layer 16 nearest to the first main surface 12a.

The second outer layer portion 15b2 is located near the second main surface 12b of the multilayer body 12 and is an aggregate of multiple dielectric layers 14 located between the second main surface 12b and the inner electrode layer 16 nearest to the second main surface 12b.

A region that is sandwiched between the first outer layer portion 15b1 and the second outer layer portion 15b2 corresponds to the effective layer portion 15a.

For example, the material of the dielectric layers 14 can be a dielectric material. For example, the dielectric material can be dielectric ceramic that includes BaTiO₃, CaTiO₃, SrTiO₃, or CaZnO₃ as a main component. A material acquired by adding a sub-component such as an Mn compound, an Fe compound, a Cr compound, a Co compound, or an Ni compound to the main component may be used.

The number of the dielectric layers 14 is not particularly limited but is preferably, for example, no less than 5 and no more than 2000 with the first outer layer portion 15b1 and the second outer layer portion 15b2 included. The thicknesses of the dielectric layers 14 are preferably no less than about 0.30 μm and no more than about 5.0 μm, for example.

As illustrated in FIG. 5, the inner electrode layers 16 include first inner electrode layers 16a and second inner electrode layers 16b. The first inner electrode layers 16a and the second inner electrode layers 16b are stacked in turn with dielectric layers 14 interposed therebetween.

The first inner electrode layers 16a are disposed on surfaces of the dielectric layers 14. The first inner electrode layers 16a include first facing electrode portions 18a that face the second inner electrode layers 16b and first extension electrode portions 20a that are located at ends of the first inner electrode layers 16a and that extend from the first facing electrode portions 18a to the first end surface 12e of the multilayer body 12. End portions of the first extension electrode portions 20a extend to the first end surface 12e and are exposed.

The shapes of the first facing electrode portions 18a of the first inner electrode layers 16a are not particularly limited but preferably have a rectangular shape in plan view. The shapes may be such that corner portions are rounded in plan view, or the corner portions are oblique in plan view (tapered shape). A tapered shape in plan view such that an inclination in a direction is shown may be also acceptable.

The shapes of the first extension electrode portions 20a of the first inner electrode layers 16a are not particularly limited but preferably have a rectangular shape in plan view. The shapes may be such that corner portions are rounded in plan view, or the corner portions are oblique in plan view (tapered shape). A tapered shape in plan view such that an inclination in a direction is shown may be also acceptable.

The widths of the first facing electrode portions 18a of the first inner electrode layers 16a and the widths of the first extension electrode portions 20a of the first inner electrode layers 16a may be equal to each other, or either of these may be less than the other.

The second inner electrode layers 16b are disposed on surfaces of dielectric layers 14 that differ from dielectric layers 14 on which the first inner electrode layers 16a are disposed. Second facing electrode portions 18b that face the first inner electrode layers 16a, and second extension electrode portions 20b that are located at ends of the second inner electrode layers 16b and that extend from the second facing electrode portions 18b to the second end surface 12f of the multilayer body 12 are included. End portions of the second extension electrode portions 20b extend to the second end surface 12f and are exposed.

The shapes of the second facing electrode portions 18b of the second inner electrode layers 16b are not particularly limited but preferably have a rectangular shape in plan view. The shapes may be such that corner portions are rounded in plan view, or the corner portions are oblique in plan view (tapered shape). A tapered shape in plan view such that an inclination in a direction is shown may be also acceptable.

The shapes of the second extension electrode portions 20b of the second inner electrode layers 16b are not particularly limited but preferably have a rectangular shape in plan view. The shapes may be such that corner portions are rounded in plan view, or the corner portions are oblique in plan view (tapered shape). A tapered shape in plan view such that an inclination in a direction is shown may be also acceptable.

The widths of the second facing electrode portions 18b of the second inner electrode layers 16b and the widths of the second extension electrode portions 20b of the second inner electrode layers 16b may be equal to each other, or either of these may be less than the other.

For example, the first inner electrode layers 16a and the second inner electrode layers 16b may include an appropriate conductive material that includes Ni as a main component and that includes metal such as Cu, Ag, Pd, Au, or an alloy that includes at least one kind of these metals such as an Ag—Pd alloy. The inner electrode layers 16 may further include dielectric particles that have the same composition as the ceramic that is include in the dielectric layers 14.

The first inner electrode layers 16a and the second inner electrode layers 16b may include Sn. The first inner electrode layers 16a and the second inner electrode layers 16b that include Sn enable an electric field to be prevented from concentrating on the interfaces between the first inner electrode layers 16a and the dielectric layers 14 and between the second inner electrode layers 16b and the dielectric layers 14, and this leads to an improvement in high-temperature load reliability. Even when only the inner electrode layers 16 of the first inner electrode layers 16a or the second inner electrode layers 16b include Sn, effects can be sufficiently exerted.

The thicknesses of the inner electrode layers 16, that is, the first inner electrode layers 16a and the second inner electrode layers 16b are preferably no less than about 0.30 μm and no more than about 1.0 μm, for example. The number of the first inner electrode layers 16a and the second inner electrode layers 16b is preferably no less than 5 and no more than 2000 in total, for example.

As for the multilayer body 12, as illustrated in FIG. 5, end portions (referred to below as “L gaps”) 22b of the multilayer body 12 are located between end portions of the first inner electrode layers 16a opposite the first extension electrode portions 20a and the second end surface 12f and between end portions of the second inner electrode layers 16b opposite the second extension electrode portions 20b and the first end surface 12e.

As for the multilayer body 12, as illustrated in FIG. 5, side portions (referred to below as “W gaps”) 22a of the multilayer body 12 are located between the first side surface 12c and first ends of the first facing electrode portions 18a and the second facing electrode portions 18b in the width direction y and between the second side surface 12d and second ends of the first facing electrode portions 18a and the second facing electrode portions 18b in the width direction y.

The dimensions of the multilayer body 12 are not particularly limited, but the dimension in the length direction z is preferably no less than about 0.2 mm and no more than about 3.2 mm, the dimension in the width direction y is preferably no less than about 0.10 mm and no more than about 2.50 mm, and the dimension in the height direction x is no less than about 0.04 mm and no more than about 0.30 mm, for example. In particular, the length of the multilayer body 12 in the height direction x is preferably about 110 μm or less, for example.

As illustrated in FIG. 1 to FIG. 4, the outer electrodes 24 are disposed on the first end surface 12e and the second end surface 12f of the multilayer body 12.

The outer electrodes 24 include main surface electrodes 26 and plating layers 28 that cover the main surface electrodes 26.

The outer electrodes 24 include a first outer electrode 24a and a second outer electrode 24b.

The first outer electrode 24a is disposed on the first end surface 12e of the multilayer body 12, extends from the first end surface 12e, and is disposed on a portion of the second main surface 12b. In this case, the first outer electrode 24a is electrically connected to the first extension electrode portions 20a of the first inner electrode layers 16a. The first outer electrode 24a is not disposed on a portion of the first main surface 12a, a portion of the first side surface 12c, or a portion of the second side surface 12d. Accordingly, the first outer electrode 24a has an L-shape in sectional view.

The second outer electrode 24b is disposed on the second end surface 12f of the multilayer body 12, extends from the second end surface 12f, and is disposed on a portion of the second main surface 12b. In this case, the second outer electrode 24b is electrically connected to the second extension electrode portions 20b of the second inner electrode layers 16b. The second outer electrode 24b is not disposed on a portion of the first main surface 12a, a portion of the first side surface 12c, or a portion of the second side surface 12d. Accordingly, the second outer electrode 24b has an L-shape in sectional view.

In the multilayer body 12, the first facing electrode portions 18a of the first inner electrode layers 16a and the second facing electrode portions 18b of the second inner electrode layers 16b face each other with the dielectric layers 14 interposed therebetween, and consequently, electrostatic capacitance is generated. For this reason, the electrostatic capacitance can be acquired between the first outer electrode 24a to which the first inner electrode layers 16a are connected and the second outer electrode 24b to which the second inner electrode layers 16b are connected, and capacitor characteristics are exhibited.

The main surface electrodes 26 include a first main surface electrode 26a1 and a second main surface electrode 26b1. The first main surface electrode 26a1 and the second main surface electrode 26b1 include thin film layers that include multiple thin film electrodes in order to improve the performance.

The first main surface electrode 26a1 covers a portion of the second main surface 12b near the first end surface 12e of the multilayer body 12.

The second main surface electrode 26b1 covers a portion of the second main surface 12b near the second end surface 12f of the multilayer body 12.

The main surface electrodes 26 that are formed by using thin film layers are preferably formed by using a sputtering method or a thin film forming method such as a vapor deposition method. In particular, the main surface electrodes 26 that are formed by using thin film layers are preferably sputtering electrodes that are formed by using the sputtering method. The electrodes that are formed by using the sputtering method will now be described.

In the case where the main surface electrodes 26 are formed by using the sputtering electrodes, the sputtering electrodes are preferably formed directly on the portions of the second main surface 12b of the multilayer body 12.

For example, the main surface electrodes 26 may include Ni, Cu, Ag, Pd, Ag—Pd alloy, or metal such as Au. In this case, the main surface electrodes 26 preferably include the same dielectric material as the dielectric ceramic that is include in the dielectric layers 14 as a common material. When being fired, the main surface electrodes 26 that include the common material can shrink in a manner close to a manner in which the multilayer body 12 shrinks, and the main surface electrodes 26 can be prevented from being separated from the multilayer body 12.

The plating layers 28 include a first plating layer 28a and a second plating layer 28b. The first plating layer 28a covers the first main surface electrode 26a1 that is disposed on the second main surface 12b, extends from the second main surface 12b, and covers the first end surface 12e. The second plating layer 28b covers the second main surface electrode 26b1 that is disposed on the second main surface 12b, extends from the second main surface 12b, and covers the second end surface 12f.

The plating layers 28 may be multiple layers. The plating layers 28 preferably include lower plating layers 30 that cover the main surface electrodes 26 and upper plating layers 32 that cover the lower plating layers 30. For example, the upper plating layers 32 of the plating layers 28 include at least one of, for example, Ni, Sn, Cu, Ag, Pd, Ag—Pd alloy, or Au.

The lower plating layers 30 include a first lower plating layer 30a and a second lower plating layer 30b. The lower plating layers 30 are disposed on the main surface electrodes 26, the first end surface 12e, and the second end surface 12f.

The first lower plating layer 30a is disposed on the first end surface 12e of the multilayer body 12 on which no main surface electrode is disposed and covers the first main surface electrode 26a1 that is disposed on the second main surface 12b.

The second lower plating layer 30b is disposed on the second end surface 12f of the multilayer body 12 on which no main surface electrode is disposed and covers the second main surface electrode 26b1 that is disposed on the second main surface 12b.

The thickness of the lower plating layers 30 per layer is preferably no less than about 2 μm and no more than about 11 μm, for example.

The upper plating layers 32 include a first upper plating layer 32a and a second upper plating layer 32b.

The first upper plating layer 32a covers the first lower plating layer 30a. Specifically, the first upper plating layer 32a is preferably disposed on a surface of the first lower plating layer 30a along the first end surface 12e so as to extend to the second main surface 12b along the surface of the first lower plating layer 30a.

The second upper plating layer 32b covers the second lower plating layer 30b. Specifically, the second upper plating layer 32b is preferably disposed on a surface of the second lower plating layer 30b along the second end surface 12f so as to extend to the second main surface 12b along the surface of the second lower plating layer 30b.

The thickness of the upper plating layers 32 per layer is preferably no less than about 2 μm and no more than about 11 μm, for example.

As for a two-layer structure according to the present example embodiment, the lower plating layers 30 are Ni plating layers, and the upper plating layers 32 are Sn plating layers. When the lower plating layers 30 are Ni plating layers, the main surface electrodes 26 can be prevented from being eroded by solder when the multilayer ceramic electronic component 10 is mounted on a mounting substrate. When the upper plating layers 32 are Sn plating layers, the wettability of the solder when the multilayer ceramic electronic component 10 is mounted on the mounting substrate can be improved, and the multilayer ceramic electronic component 10 can be easily mounted.

The bumps 40 that are included in the multilayer ceramic electronic component 10 include a first bump 40a and a second bump 40b.

The first bump 40a is disposed on a surface of the first outer electrode 24a near the second main surface 12b. The second bump 40b is disposed on a surface of the second outer electrode 24b near the second main surface 12b.

As for a multilayer ceramic electronic component 10 according to an example embodiment of the present invention, the second main surface 12b serves as a mounting surface to face the mounting substrate.

A main component in the bumps 40 is an intermetallic compound that includes at least one of a high-melting-point metal selected from Cu and Ni or a low-melting-point metal of Sn. In particular, the intermetallic compound is preferably generated by a reaction between Sn and Cu—Ni alloy. The intermetallic compound has advantages of high reaction speed and little deformation when being generated. The high-melting-point metal that is include in the intermetallic compound may further include Ag. When the bumps 40 include the intermetallic compound, the bumps 40 have hardness that can reduce stress concentrated on the multilayer body 12 at an edge portion of an outer electrode that is located near a main surface of the multilayer ceramic capacitor at the mounting surface when the stress concentrated due to the impact of the mounter is transmitted to the bumps 40.

A condition of, for example, about 0.5<t1/t2<about 0.75 is satisfied, where t1 is the thickness of each of the first bump 40a and the second bump 40b in the height direction x, and t2 is the thickness of the multilayer body 12 in the height direction x.

The thickness t1 of each of the first bump 40a and the second bump 40b in the height direction x is preferably no less than about 20 μm and no more than about 30 μm, for example.

For example, the thickness t1 of each of the first bump 40a and the second bump 40b in the height direction x and the thickness t2 of the multilayer body 12 in the height direction x are measured by observing the appearance by using a digital microscope (KEYENCE CORPORATION: VHX-8000) with magnification being no less than 500 and no more than 2000.

A condition of, for example, about 0.6<w1/w2<about 0.9 is preferably satisfied, where w1 is the dimension of each of the first bump 40a and the second bump 40b in the width direction y, and w2 is the dimension of the multilayer body 12 in the width direction y.

For example, the dimension w1 of each of the first bump 40a and the second bump 40b in the width direction y and the dimension w2 of the multilayer body 12 in the width direction y are measured by observing the appearance by using the digital microscope (KEYENCE CORPORATION: VHX-8000) with the magnification being no less than 500 and no more than 2000.

The Vickers hardness (HV) of the first bump 40a and the second bump 40b is preferably no less than 30 and no more than 40. This enables the bumps 40 to reduce the stress concentrated on the multilayer body 12 at an edge portion of an outer electrode that is located near a main surface of a multilayer ceramic capacitor at the mounting surface when the stress concentrated due to the impact of the mounter is transmitted to the bumps 40. The Vickers hardness is acquired by using a measurement method conforming to JIS Z 2244.

The dimension of the multilayer ceramic capacitor 10A that includes the multilayer body 12, the first outer electrode 24a, and the second outer electrode 24b in the length direction z is referred to as an L dimension, the dimension of the multilayer ceramic capacitor 10A that includes the multilayer body 12, the first outer electrode 24a, and the second outer electrode 24b in the height direction x is referred to as a T dimension, and the dimension of the multilayer ceramic capacitor 10A that includes the multilayer body 12, the first outer electrode 24a, and the second outer electrode 24b in the width direction y is referred to as a W dimension.

As for the multilayer ceramic electronic component 10 illustrated in FIG. 1, the multilayer ceramic capacitor 10A includes the first bump 40a that is disposed on the surface of the first outer electrode 24a near the second main surface 12b and the second bump 40b that is disposed on the surface of the second outer electrode 24b near the second main surface 12b, and the condition of, for example, about 0.5<t1/t2<about 0.75 is satisfied, where t1 is the thickness of each of the first bump 40a and the second bump 40b in the height direction x, and t2 is the thickness of the multilayer body 12 in the height direction x. Accordingly, an impact on the multilayer ceramic electronic component 10 due to a mounter nozzle is transmitted to the bumps 40 particularly when the multilayer ceramic electronic component 10 that is thin is mounted on the mounting substrate. This enables the multilayer body to be prevented from being damaged due to stress caused by the impact and concentrated on an edge portion of an outer electrode that is located near a main surface of the multilayer ceramic capacitor.

Modifications (a first modification to a third modification) of the multilayer ceramic electronic component according to the example embodiments will now be described. As for the modifications, components corresponding to those according to the example embodiments described above are designated by using like reference signs, and the detailed description thereof is omitted.

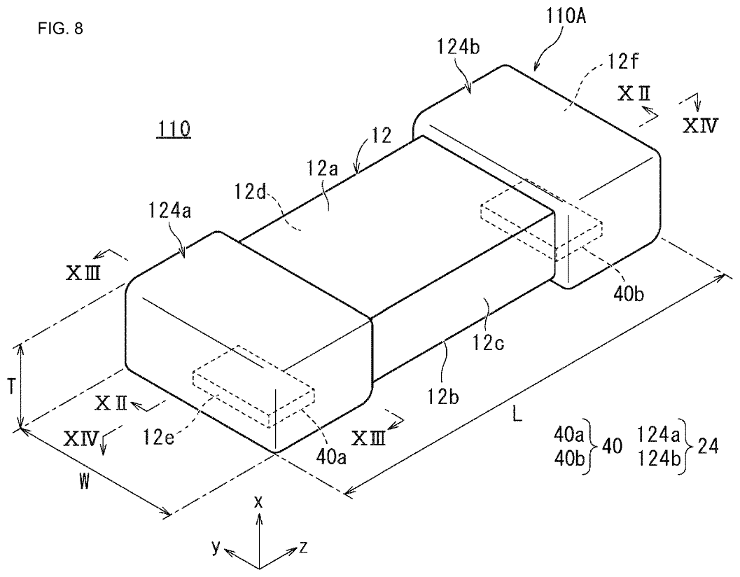

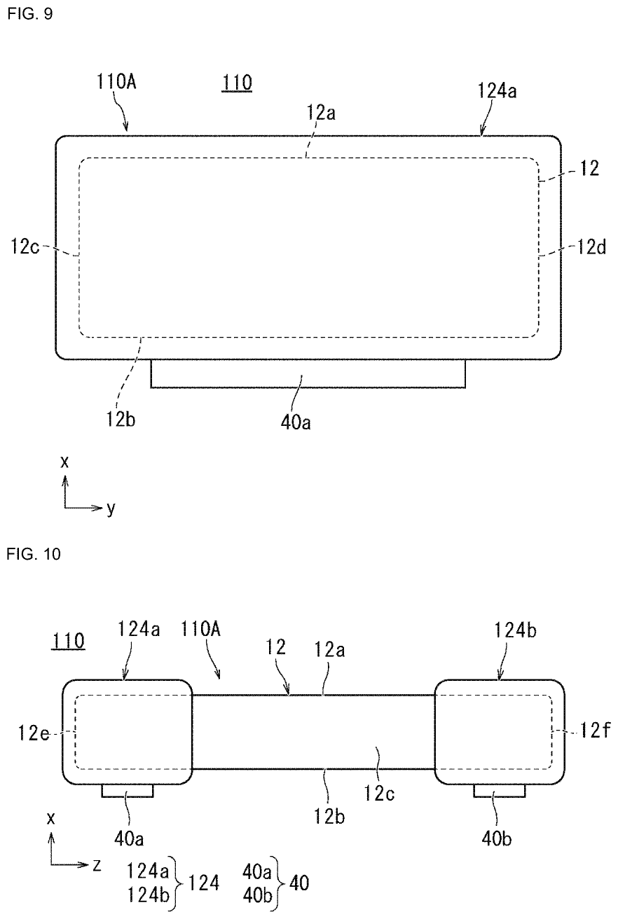

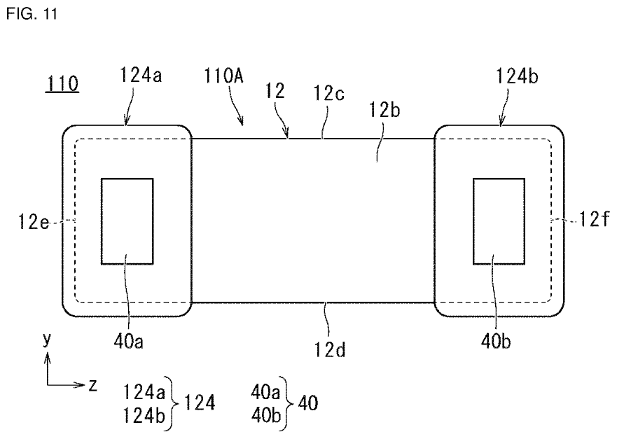

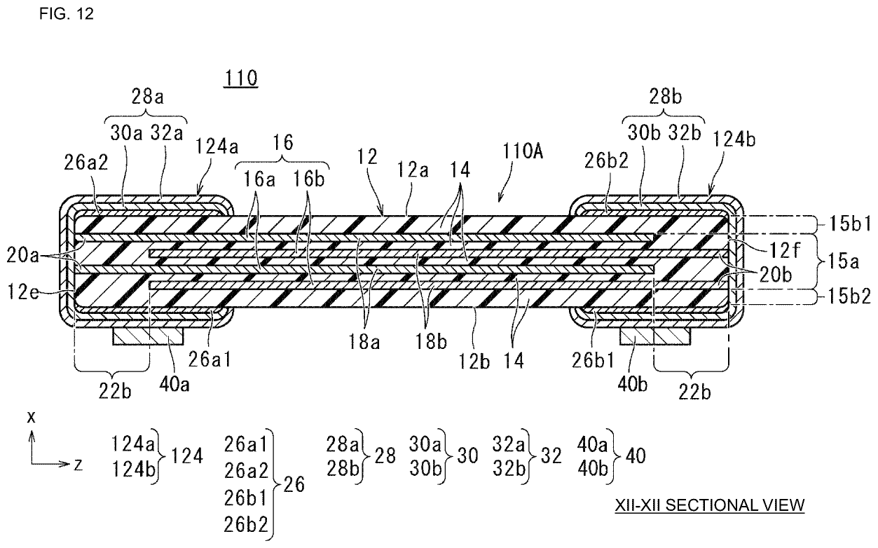

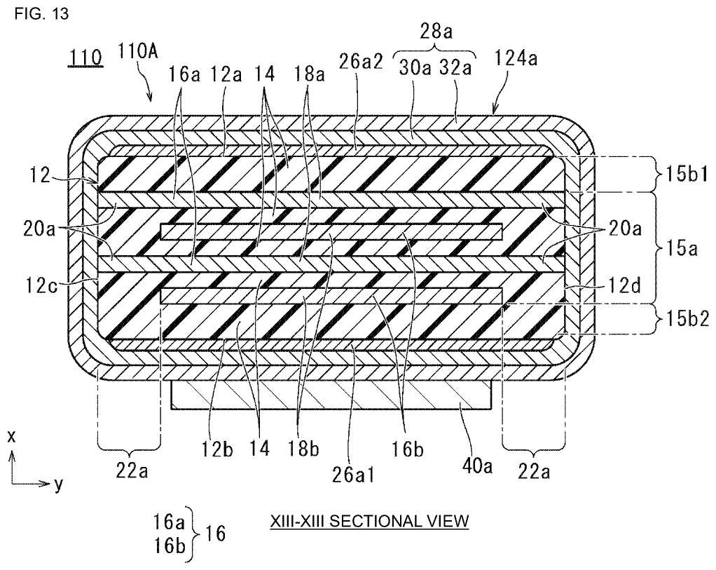

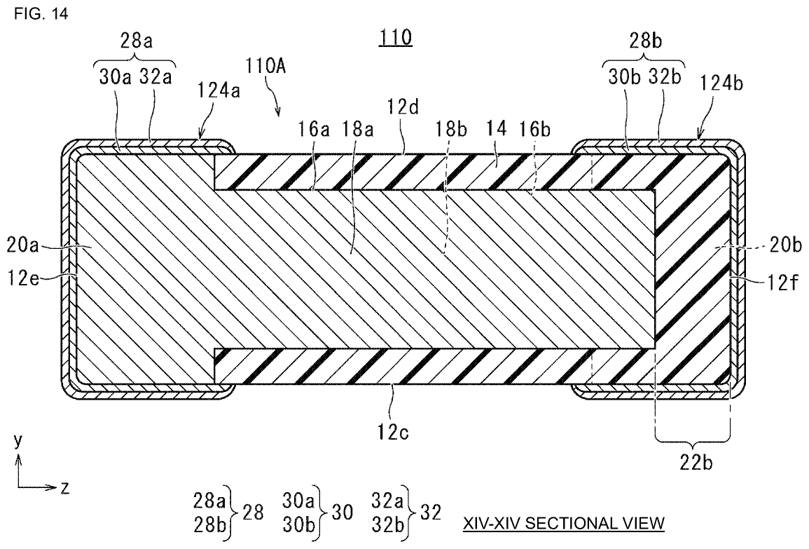

A multilayer ceramic electronic component 110 according to the first modification to the first example embodiment will be first described. FIG. 8 illustrates a perspective view of an example of the multilayer ceramic electronic component according to the first modification to the first example embodiment of the present invention. FIG. 9 illustrates a right-hand side view of an example of the multilayer ceramic electronic component according to the first modification to the first example embodiment of the present invention. FIG. 10 illustrates a front view of an example of the multilayer ceramic electronic component according to the first modification to the first example embodiment of the present invention. FIG. 11 illustrates a bottom view of a multilayer ceramic capacitor that is an example of the multilayer ceramic electronic component according to the first modification to the first example embodiment of the present invention. FIG. 12 illustrates a sectional view taken along line XII-XII in FIG. 8. FIG. 13 illustrates a sectional view taken along line XIII-XIII in FIG. 8. FIG. 14 illustrates a sectional view taken along line XIV-XIV in FIG. 8.

The multilayer ceramic electronic component 110 according to the first modification includes a multilayer ceramic capacitor 110A and the bumps 40.

As for the multilayer ceramic capacitor 110A according to the first modification, as illustrated in FIG. 8, outer electrodes 124 are disposed not only on the first end surface 12e, the second end surface 12f, the first main surface 12a, and the second main surface 12b, but also on the first side surface 12c and the second side surface 12d. As illustrated in FIG. 14, the shapes of the extension electrode portions of the inner electrode layers 16 are changed.

As illustrated in FIG. 12 and FIG. 13, the inner electrode layers 16 include the first inner electrode layers 16a and the second inner electrode layers 16b. The first inner electrode layers 16a and the second inner electrode layers 16b are stacked in turn with dielectric layers 14 interposed therebetween.

The first inner electrode layers 16a are disposed on surfaces of the dielectric layers 14. The first inner electrode layers 16a include the first facing electrode portions 18a that face the second inner electrode layers 16b and the first extension electrode portions 20a that are located at the ends of the first inner electrode layers 16a and that extend from the first facing electrode portions 18a to the first end surface 12e of the multilayer body 12. As illustrated in FIG. 13, end portions of the first extension electrode portions 20a extend to the first end surface 12e, a portion of the first side surface 12c, and a portion of the second side surface 12d and are exposed.

The second inner electrode layers 16b are disposed on surfaces of dielectric layers 14 that differ from dielectric layers 14 on which the first inner electrode layers 16a are disposed. The second inner electrode layers 16b include the second facing electrode portions 18b that face the first inner electrode layers 16a, and the second extension electrode portions 20b that are located at ends of the second inner electrode layers 16b and that extend from the second facing electrode portions 18b to the second end surface 12f of the multilayer body 12. As illustrated in FIG. 13, end portions of the second extension electrode portions 20b extend to the second end surface 12f, a portion of the first side surface 12c, and a portion of the second side surface 12d and are exposed.

This enables the lower plating layers 30 to be formed also on the first extension electrode portions 20a and the second extension electrode portions 20b that are exposed from the first side surface 12c and the second side surface 12d. As a result, the outer electrodes 124 can be formed also on the first side surface 12c and the second side surface 12d.

The outer electrodes 124 include the main surface electrodes 26 and the plating layers 28 that cover the main surface electrodes 26.

The outer electrodes 124 include a first outer electrode 124a and a second outer electrode 124b.

The first outer electrode 124a is disposed on the first end surface 12e of the multilayer body 12, a portion of the first main surface 12a, a portion of the second main surface 12b, a portion of the first side surface 12c, and a portion of the second side surface 12d. In this case, the first outer electrode 124a is electrically connected to the first extension electrode portions 20a of the first inner electrode layers 16a.

The second outer electrode 124b is disposed on the second end surface 12f of the multilayer body 12, a portion of the first main surface 12a, a portion of the second main surface 12b, a portion of the first side surface 12c, and a portion of the second side surface 12d. In this case, the second outer electrode 124b is electrically connected to the second extension electrode portions 20b of the second inner electrode layers 16b.

The main surface electrodes 26 include the first main surface electrode 26a1, the second main surface electrode 26b1, a third main surface electrode 26a2, and a fourth main surface electrode 26b2. The first main surface electrode 26a1, the second main surface electrode 26b1, the third main surface electrode 26a2, and the fourth main surface electrode 26b2 are formed by using thin film layers that include multiple thin film electrodes in order to improve the performance.

The first main surface electrode 26a1 covers a portion of the second main surface 12b near the first end surface 12e of the multilayer body 12. The third main surface electrode 26a2 covers a portion of the first main surface 12a near the first end surface 12e of the multilayer body 12. The first outer electrode 124a includes the first main surface electrode 26a1 and the third main surface electrode 26a2.

The second main surface electrode 26b1 covers a portion of the second main surface 12b near the second end surface 12f of the multilayer body 12. The fourth main surface electrode 26b2 covers a portion of the first main surface 12a near the second end surface 12f of the multilayer body 12. The second outer electrode 124b includes the second main surface electrode 26b1 and the fourth main surface electrode 26b2.

The plating layers 28 include the first plating layer 28a and the second plating layer 28b. The first plating layer 28a covers the first main surface electrode 26a1 and the third main surface electrode 26a2. The second plating layer 28b covers the second main surface electrode 26b1 and the fourth main surface electrode 26b2. The structure of the plating layers 28 of the multilayer ceramic capacitor 110A according to the first modification is the same as the structure of the plating layers 28 of the multilayer ceramic capacitor 10A.

The bumps 40 that are included in the multilayer ceramic electronic component 110 include the first bump 40a and the second bump 40b.

The first bump 40a is disposed on the surface of the first outer electrode 124a near the second main surface 12b. The second bump 40b is disposed on the surface of the second outer electrode 124b near the second main surface 12b.

The multilayer ceramic electronic component 110 according to the first modification illustrated in FIG. 8 exerts the same effects as the multilayer ceramic electronic component 10 in FIG. 1. That is, the outer electrodes 124 are disposed on the first main surface and the side surfaces 12c and 12d of the multilayer ceramic capacitor 110A of the multilayer ceramic electronic component 110. Accordingly, solder gets wet and spreads over the outer electrodes 124 during mounting, and consequently, adhesion force to the mounting substrate can be maintained.

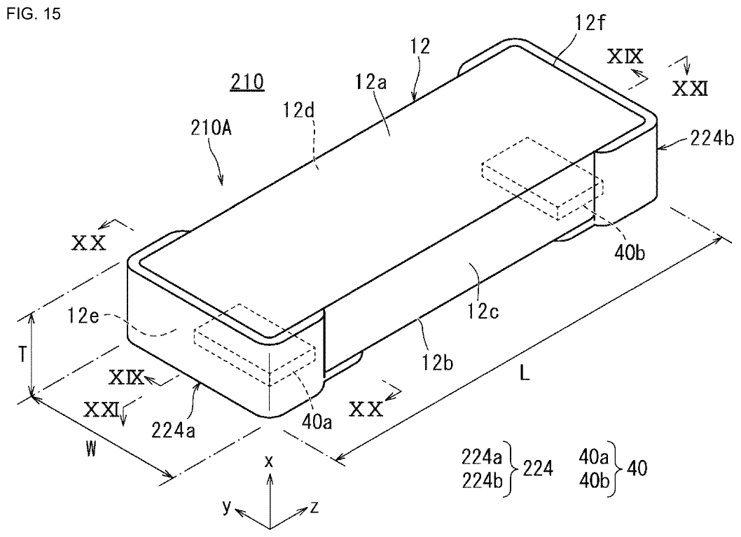

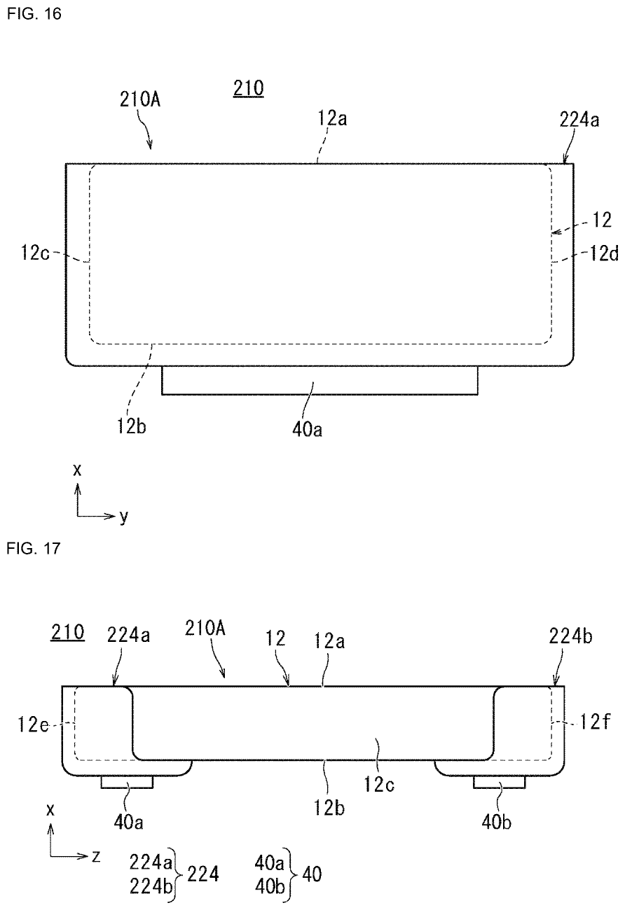

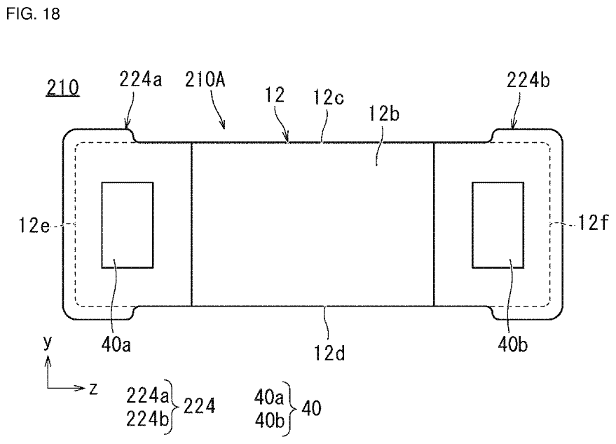

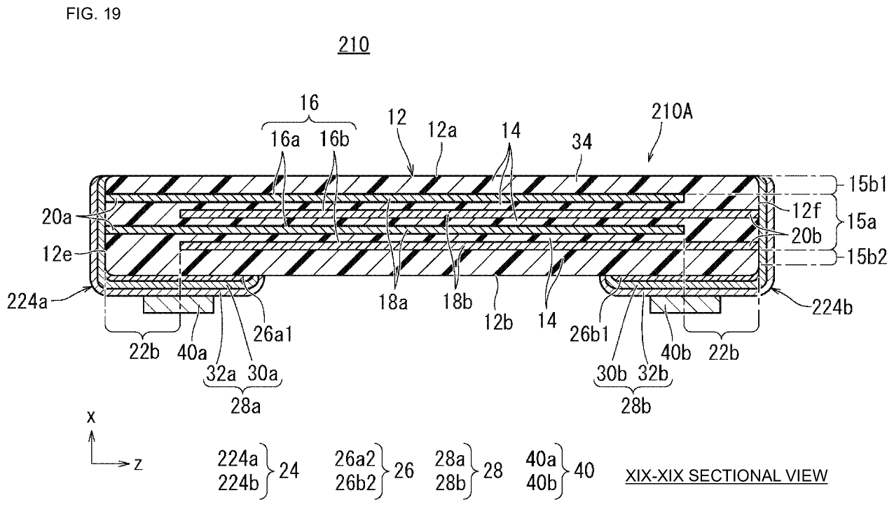

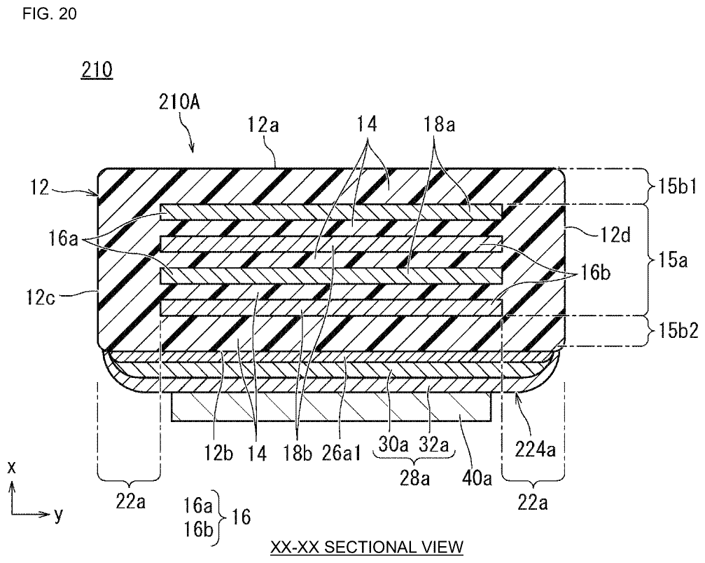

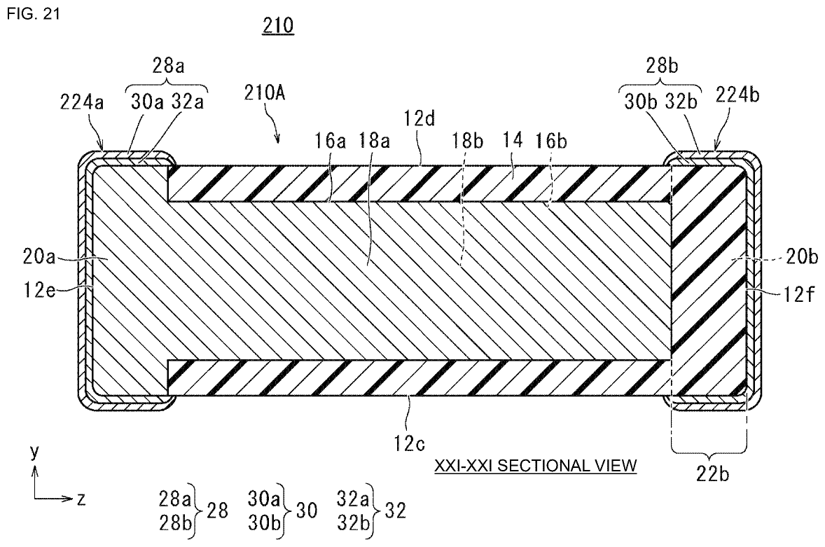

A multilayer ceramic electronic component 210 according to the second modification will now be described. FIG. 15 illustrates a perspective view of an example of the multilayer ceramic electronic component according to the second modification to the first example embodiment of the present invention. FIG. 16 illustrates a right-hand side view of an example of the multilayer ceramic electronic component according to the second modification to the first example embodiment of the present invention. FIG. 17 illustrates a front view of an example of the multilayer ceramic electronic component according to the second modification to the first example embodiment of the present invention. FIG. 18 illustrates a bottom view of a multilayer ceramic capacitor that is an example of the multilayer ceramic electronic component according to the second modification to the first example embodiment of the present invention. FIG. 19 illustrates a sectional view taken along line XIX-XIX in FIG. 15. FIG. 20 illustrates a sectional view taken along line XX-XX in FIG. 15. FIG. 21 illustrates a sectional view taken along line XXI-XXI in FIG. 15.

The multilayer ceramic electronic component 210 according to the second modification includes a multilayer ceramic capacitor 210A and the bumps 40.

As illustrated in FIG. 19 and FIG. 20, the inner electrode layers 16 include the first inner electrode layers 16a and the second inner electrode layers 16b. The first inner electrode layers 16a and the second inner electrode layers 16b are stacked in turn with dielectric layers 14 interposed therebetween.

The first inner electrode layers 16a are disposed on surfaces of the dielectric layers 14. The first inner electrode layers 16a include the first facing electrode portions 18a that face the second inner electrode layers 16b and the first extension electrode portions 20a that are located at the ends of the first inner electrode layers 16a and that extend from the first facing electrode portions 18a to the first end surface 12e of the multilayer body 12. As illustrated in FIG. 21, end portions of the first extension electrode portions 20a extend to the first end surface 12e, a portion of the first side surface 12c, and a portion of the second side surface 12d and are exposed. The dimensions in the length direction z of the portions of the first extension electrode portions 20a of the first inner electrode layers 16a that extend to the portion of the first side surface 12c and the portion of the second side surface 12d and that are exposed are smaller than the dimensions in the length direction z of the portions of the first extension electrode portions 20a of the first inner electrode layers 16a that extend to the portion of the first side surface 12c and the portion of the second side surface 12d and that are exposed as illustrated in FIG. 14.

The second inner electrode layers 16b are disposed on surfaces of dielectric layers 14 that differ from dielectric layers 14 on which the first inner electrode layers 16a are disposed. The second inner electrode layers 16b include the second facing electrode portions 18b that face the first inner electrode layers 16a, and the second extension electrode portions 20b that are located at ends of the second inner electrode layers 16b and that extend from the second facing electrode portions 18b to the second end surface 12f of the multilayer body 12. As illustrated in FIG. 21, end portions of the second extension electrode portions 20b extend to the second end surface 12f, a portion of the first side surface 12c, and a portion of the second side surface 12d and are exposed. The dimensions in the length direction z of the portions of the second extension electrode portions 20b of the second inner electrode layers 16b that extend to the portion of the first side surface 12c and the portion of the second side surface 12d and that are exposed are smaller than the dimensions in the length direction z of the portions of the second extension electrode portions 20b of the second inner electrode layers 16b that extend to the portion of the first side surface 12c and the portion of the second side surface 12d and that are exposed as illustrated in FIG. 14.

As illustrated in FIG. 15 and FIG. 19, the multilayer ceramic capacitor 210A according to the second modification includes outer electrodes 224 that have an L-shape in sectional view. The outer electrodes 224 include a first outer electrode 224a and a second outer electrode 224b.

As for the multilayer ceramic capacitor 210A that is the multilayer ceramic electronic component according to the second modification, as illustrated in FIG. 15, the first outer electrode 224a that has an L-shape in sectional view is disposed on the first end surface 12e, extends from the first end surface 12e, and is disposed on the second main surface 12b. The first outer electrode 224a covers, from the first end surface 12e, the first extension electrode portions 20a of the first inner electrode layers 16a that are exposed from the first side surface 12c and the second side surface 12d. In this case, the first outer electrode 224a may be partly disposed so as to surround the first main surface 12a.

As for the multilayer ceramic capacitor 210A, as illustrated in FIG. 15, the second outer electrode 224b that has an L-shape in sectional view is disposed on the second end surface 12f, extends from the second end surface 12f, and is disposed on the second main surface 12b. The second outer electrode 224b covers, from the second end surface 12f, the second extension electrode portions 20b of the second inner electrode layers 16b that are exposed from the first side surface 12c and the second side surface 12d. In this case, the second outer electrode 224b may be partly disposed so as to surround the first main surface 12a.

The first outer electrode 224a is disposed on the first end surface 12e, extends from the first end surface 12e, and is disposed on the first main surface 12a, and the second outer electrode 224b is disposed on the second end surface 12f, extends from the second end surface 12f, and is disposed on the first main surface 12a. At this time, the first outer electrode 224a may be partly disposed so as to surround the second main surface 12b, and the second outer electrode 224b may be partly disposed so as to surround the second main surface 12b. At this time, only the third main surface electrode and the fourth main surface electrode are disposed on the first main surface 12a.

The bumps 40 that are included in the multilayer ceramic electronic component 210 include the first bump 40a and the second bump 40b.

The first bump 40a is disposed on the surface of the first outer electrode 124a near the second main surface 12b. The second bump 40b is disposed on the surface of the second outer electrode 124b near the second main surface 12b.

The structure of the plating layers 28 of the multilayer ceramic capacitor 210A according to the second modification is the same as the structure of the plating layers 28 of the multilayer ceramic capacitor 10A.

The multilayer ceramic electronic component 210 according to the second modification illustrated in FIG. 15 exerts the same effects as the multilayer ceramic electronic component 110 in FIG. 8 and exerts the following effects. That is, the magnitude of the range of the outer electrodes 224 that are disposed on the side surfaces 12c and 12d of the multilayer ceramic capacitor 210A of the multilayer ceramic electronic component 210 is smaller than the magnitude of the range of the outer electrodes 124 that are disposed on the side surfaces 12c and 12d of the multilayer ceramic capacitor 110A of the multilayer ceramic electronic component 110 illustrated in FIG. 8. Accordingly, solder is prevented from getting wet and spreading over an upper surface (the first main surface 12a) during mounting, and the adhesion force to the mounting substrate can be maintained.

A multilayer ceramic electronic component 310 according to the third modification will now be described.

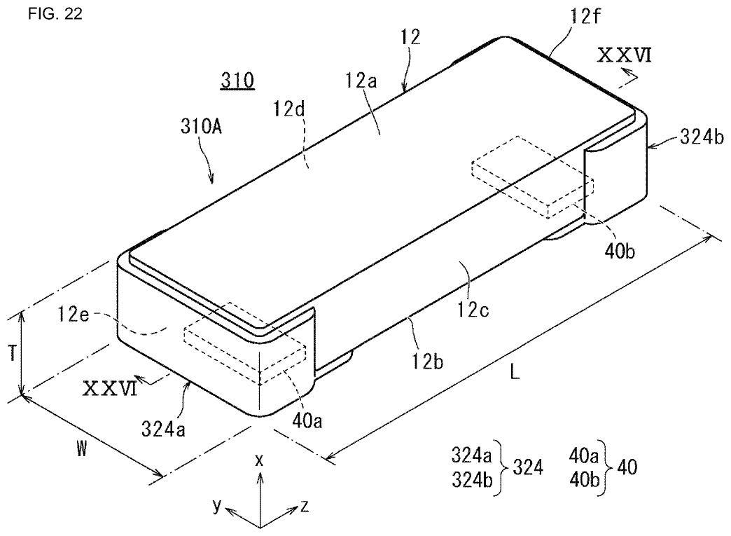

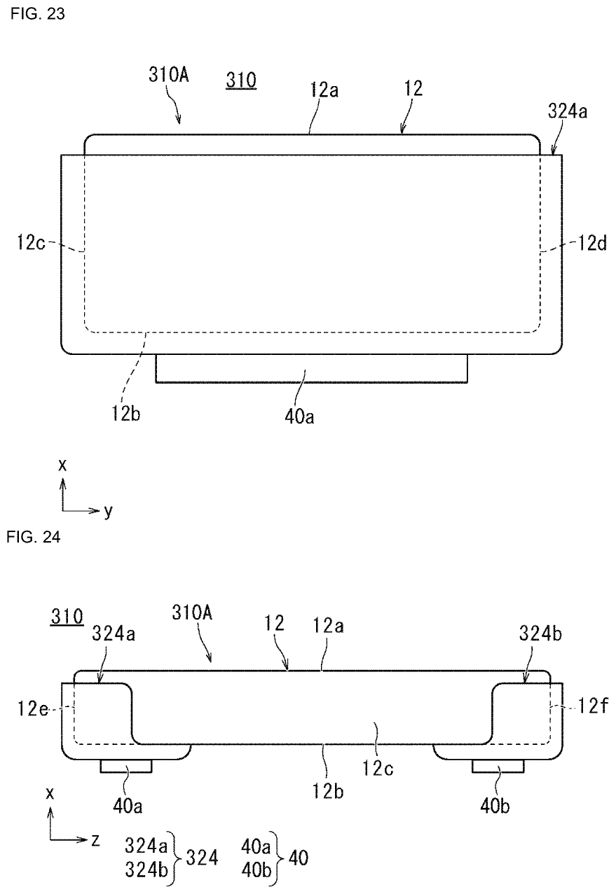

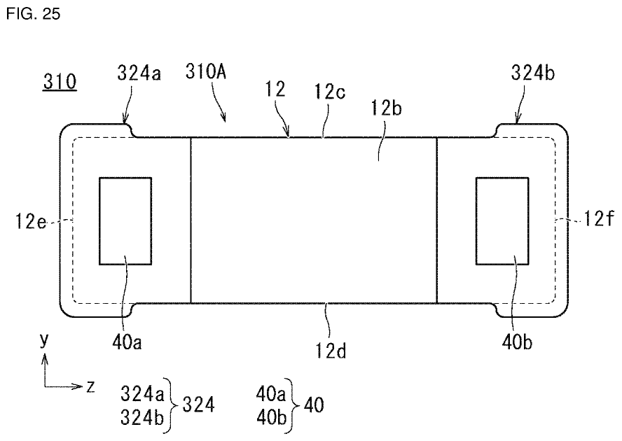

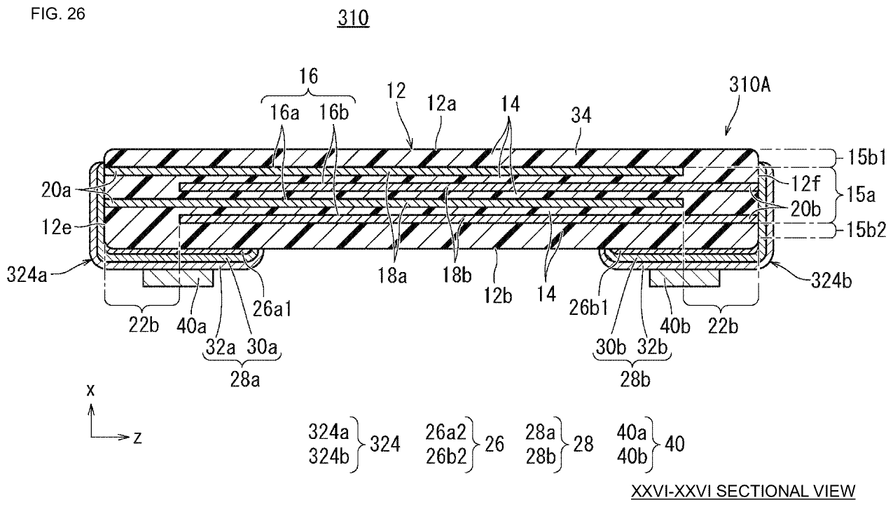

FIG. 22 illustrates a perspective view of an example of the multilayer ceramic electronic component according to the third modification to the first example embodiment of the present invention. FIG. 23 illustrates a right-hand side view of an example of the multilayer ceramic electronic component according to the third modification to the first example embodiment of the present invention. FIG. 24 illustrates a front view of an example of the multilayer ceramic electronic component according to the third modification to the first example embodiment of the present invention. FIG. 25 illustrates a bottom view of a multilayer ceramic capacitor that is an example of the multilayer ceramic electronic component according to the third modification to the first example embodiment of the present invention. FIG. 26 illustrates a sectional view taken along line XVI-XVI in FIG. 22.

The multilayer ceramic electronic component 310 according to the third modification includes a multilayer ceramic capacitor 310A and the bumps 40.

As illustrated in FIG. 26, the inner electrode layers 16 include the first inner electrode layers 16a and the second inner electrode layers 16b. The first inner electrode layers 16a and the second inner electrode layers 16b are stacked in turn with dielectric layers 14 interposed therebetween. The structure of the inner electrode layers 16 is the same as the structure of the inner electrode layers 16 of the multilayer ceramic capacitor 210A that is included in the multilayer ceramic electronic component 210 according to the second modification.

As illustrated in FIG. 22 and FIG. 26, the multilayer ceramic capacitor 310A according to the third modification includes outer electrodes 324 that have an L-shape in sectional view. The outer electrodes 324 include a first outer electrode 324a and a second outer electrode 324b.

As for the multilayer ceramic capacitor 310A that is the multilayer ceramic electronic component according to the third modification, as illustrated in FIG. 22, the first outer electrode 324a that has an L-shape in sectional view is disposed on the first end surface 12e, extends from the first end surface 12e, and is disposed on the second main surface 12b. The first outer electrode 324a covers, from the first end surface 12e, the first extension electrode portions 20a of the first inner electrode layers 16a that are exposed from the first side surface 12c and the second side surface 12d. In this case, the first outer electrode 324a does not extend to the first main surface 12a.

As for the multilayer ceramic capacitor 310A, as illustrated in FIG. 22, the second outer electrode 324b that has an L-shape in sectional view is disposed on the second end surface 12f, extends from the second end surface 12f, and is disposed on the second main surface 12b. The second outer electrode 324b covers, from the second end surface 12f, the second extension electrode portions 20b of the second inner electrode layers 16b that are exposed from the first side surface 12c and the second side surface 12d. In this case, the second outer electrode 324b does not extend to the first main surface 12a.

The bumps 40 that are included in the multilayer ceramic electronic component 310 include the first bump 40a and the second bump 40b.

The first bump 40a is disposed on the surface of the first outer electrode 324a near the second main surface 12b. The second bump 40b is disposed on the surface of the second outer electrode 324b near the second main surface 12b.

The multilayer ceramic electronic component 310 according to the third modification illustrated in FIG. 22 exerts the same effects as the multilayer ceramic electronic component 210 in FIG. 15 and exerts the following effects. That is, the magnitude of the range of the outer electrodes 324 that are disposed on the side surfaces 12c and 12d of the multilayer ceramic capacitor 310A of the multilayer ceramic electronic component 310 is smaller than the magnitude of the range of the outer electrodes 124 that are disposed on the side surfaces 12c and 12d of the multilayer ceramic capacitor 110A of the multilayer ceramic electronic component 110 illustrated in FIG. 8. Accordingly, solder is prevented from getting wet and spreading over an upper surface (the first main surface 12a) during mounting, the adhesion force to the mounting substrate can be maintained, and the amount of the solder can be reduced.

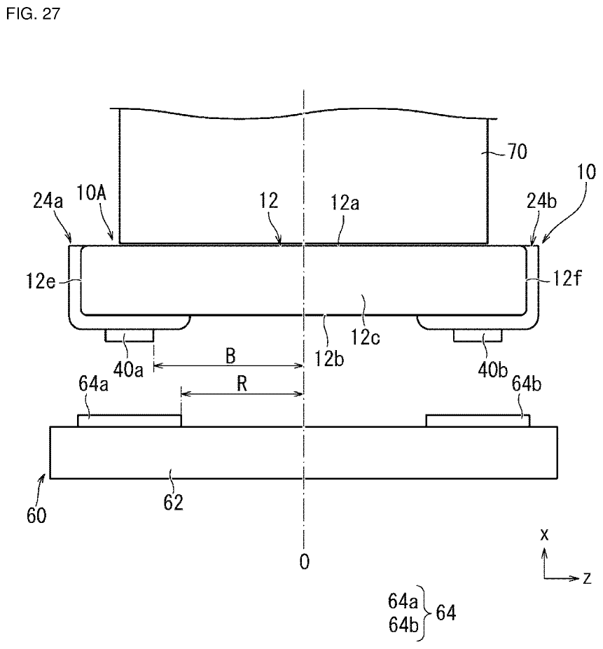

In a state that will now be described, the multilayer ceramic electronic component 10 is mounted on a mounting substrate 60 by using a mounter nozzle 70. FIG. 27 illustrates a state in which the multilayer ceramic electronic component according to the first example embodiment of the present invention is mounted on the mounting substrate.

As illustrated in FIG. 27, the multilayer ceramic electronic component 10 according to the first example embodiment is attracted by the mounter nozzle 70 and is mounted on the mounting substrate 60. The mounting substrate 60 includes a substrate core material 62 and conductive lands 64. For example, the substrate core material 62 includes a substrate composed of a material acquired by immersing epoxy resin or polyimide resin into a base material acquired by mixing glass cloth (cloth) and glass nonwoven fabric, or a ceramic substrate that is manufactured by firing a sheet acquired by mixing ceramic and glass. The substrate core material 62 may include a single-layer substrate or a multilayer substrate.

The conductive lands 64 are disposed on one of main surfaces of the substrate core material 62 defining a substrate mounting surface 62a that serves as the mounting surface of the multilayer ceramic electronic component 10.

The conductive lands 64 include a first conductive land 64a and a second conductive land 64b. The first conductive land 64a is electrically connected and mechanically joined to the first outer electrode 24a of the multilayer ceramic capacitor 10A by using a joining material. The second conductive land 64b is electrically connected and mechanically joined to the second outer electrode 24b of the multilayer ceramic capacitor 10A by using the joining material.

The material of the conductive lands 64 is not particularly limited, and examples thereof can include metal such as copper, gold, palladium, or platinum. The thicknesses of the conductive lands 64, that is, the dimensions in the height direction x are not particularly limited but are preferably, for example, no less than about 20 μm and no more than about 200 μm. For example, the joining material can be solder.

The second main surface 12b of the multilayer ceramic capacitor 10A is mounted on the mounting substrate 60 so as to face the substrate mounting surface 62a. That is, as for the multilayer ceramic capacitor 10A, the bumps 40 that are provided on the plating layers 28 are joined to the mounting substrate 60 by using the joining material.

When the multilayer ceramic capacitor 10A is thus attracted by the mounter nozzle 70 when being mounted, the first main surface 12a of the multilayer ceramic capacitor 10A comes into contact with the mounter nozzle 70. When the bumps 40 come into contact with the mounting substrate 60 (the conductive lands 64), the bumps 40 come into contact with the mounter nozzle 70. This enables the stress concentrated on the end portions of the outer electrodes 24 that are disposed near the second main surface 12b of the multilayer ceramic capacitor 10A during mounting to be reduced.

In this case, a relationship between a distance B and a distance R preferably satisfies a condition of R≤B, where B is the distance between each bump 40 and a center line that represents the center of the multilayer ceramic electronic component 10 in the length direction z, and R is the distance between the conductive land 64a and a center line that represents the midpoint between the conductive land 64a and the conductive land 64b in the length direction z.

A method of manufacturing the multilayer ceramic electronic component 10 according to the first example embodiment will now be described.

A method of manufacturing the multilayer ceramic capacitor 10A of the multilayer ceramic electronic component 10 will be first described.

Ceramic green sheets and conductive paste for inner electrodes are prepared. The ceramic green sheets and the conductive paste for inner electrode layers include a binder (such as a known organic binder) and a solvent (such as a known organic solvent).

Subsequently, the conductive paste for inner electrodes is printed on ceramic green sheets with predetermined patterns by, for example, screen printing or gravure printing, and inner electrode patterns are formed. Specifically, conductive material paste is applied to the ceramic green sheets by using, for example, the printing method described above, and consequently, conductive paste layers are formed. An example of the conductive material paste is a mixture of an organic binder and an organic solvent that are added into metal powder. As for the ceramic green sheets, ceramic green sheets for an outer layer on which no inner electrode pattern is printed are manufactured.

A multilayer sheet is manufactured by using the ceramic green sheets having the inner electrode patterns. That is, a predetermined number of ceramic green sheets for an outer layer on which no inner electrode pattern is formed are stacked, ceramic green sheets on which inner electrode patterns corresponding to the first inner electrode layers 16a are formed and ceramic green sheets on which inner electrode patterns corresponding to the second inner electrode layers 16b are formed are stacked thereon in turn, and the predetermined number of ceramic green sheets for an outer layer on which no inner electrode pattern is formed are stacked thereon. Consequently, the multilayer sheet is manufactured.

The multilayer sheet is pressed in a stacking direction by, for example, an isostatic press, and a multilayer block is manufactured.

Subsequently, the multilayer block is cut to a predetermined size, and multilayer chips are manufactured. At this time, corner portions and ridge portions of the multilayer chips may be rounded by, for example, barrel polishing.

Subsequently, the multilayer chips are fired, and consequently, the multilayer body 12 is manufactured. Firing temperature is preferably no less than about 900° C. and no more than about 1400° C., for example, although this depends on ceramic and an inner electrode material.

Subsequently, the main surface electrodes 26 that include thin film layers are formed on portions of the second main surface 12b of the multilayer body 12. The main surface electrodes 26 that are thin film layers can be formed by using, for example, the sputtering method. In other words, the main surface electrodes 26 that are thin film layers include sputtering electrodes. The sputtering electrodes can be formed by using metal that includes at least one of, for example, Ni, Cr, Cu, or Ti.

Subsequently, the lower plating layers 30 are formed so as to directly cover the main surface electrodes 26 that include thin film layers and the first end surface 12e and the second end surface 12f of the multilayer body 12 on which the main surface electrodes 26 are not disposed. When the lower plating layers 30 are formed, electrolytic plating is performed by using an electroplating bath that includes an additive or electroless plating due to a substitution reaction is performed.

Subsequently, the upper plating layers 32 are formed on surfaces of the lower plating layers 30. The upper plating layers 32 include at least one of, for example, Cu, Ni, Sn, Ag, Pd, Ag—Pd alloy, or Au, and may include a single layer or multiple layers.

The lower plating layers 30 are preferably formed as Ni plating layers, and the upper plating layers 32 are preferably formed as Sn plating layers so as to cover the lower plating layers 30.

A method of forming the bumps 40 on the multilayer ceramic capacitor 10A in order to manufacture the multilayer ceramic electronic component 10 will now be described.

At least one kind of high-melting-point metal selected from Cu or Ni to be the material of the bumps 40 and a metal material paste that includes Sn as low-melting-point metal are prepared. The metal material paste includes screen printing so as to have a desired pattern by using a squeegee with respect to the multilayer ceramic capacitor 10A that is aligned on a holding substrate. For this reason, for example, a masking jig is prepared, and the masking jig is disposed with respect to the multilayer ceramic capacitor 10A that is aligned on the holding substrate. For example, the masking jig includes a mask plate that has a rectangular shape in plan view. The masking plate has multiple through-holes that extend from a main surface thereof to another main surface. The through-holes have a rectangular shape in plan view. The size of the rectangular shape in plan view determines the sizes of the bumps 40. The metal material paste to be the first bump 40a is applied to a surface of the first outer electrode 24a of the multilayer ceramic capacitor 10A near the second main surface 12b, and the metal material paste to be the second bump 40b is applied to a surface of the second outer electrode 24b thereof near the second main surface 12b.

When the bumps 40 are formed, a method of applying the metal material paste can be an ink-jet printing method.

The multilayer ceramic electronic component 10 illustrated in FIG. 1 can be manufactured in the above manner.

An example of a multilayer ceramic electronic component 510 according to a second example embodiment of the present invention will be described. According to the present example embodiment, the multilayer ceramic electronic component 510 includes a multilayer ceramic capacitor 510A and bumps 540 and 541.

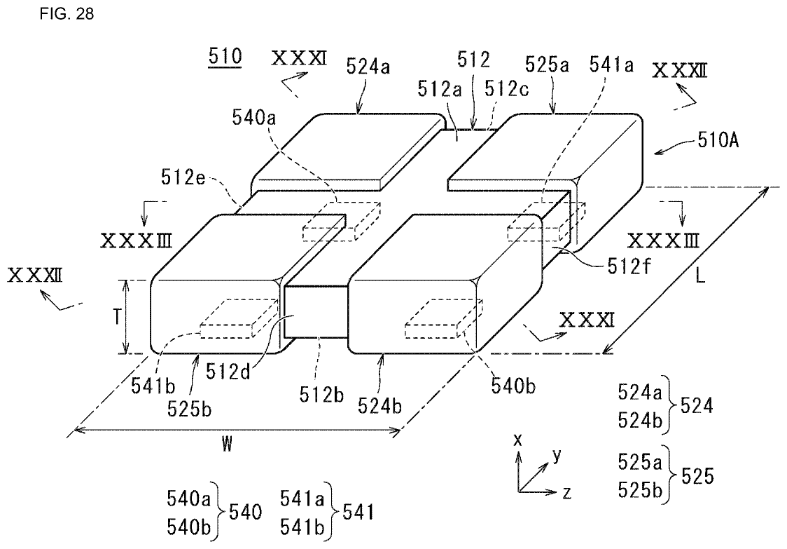

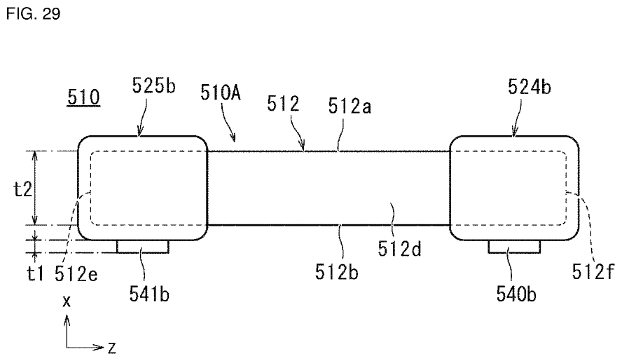

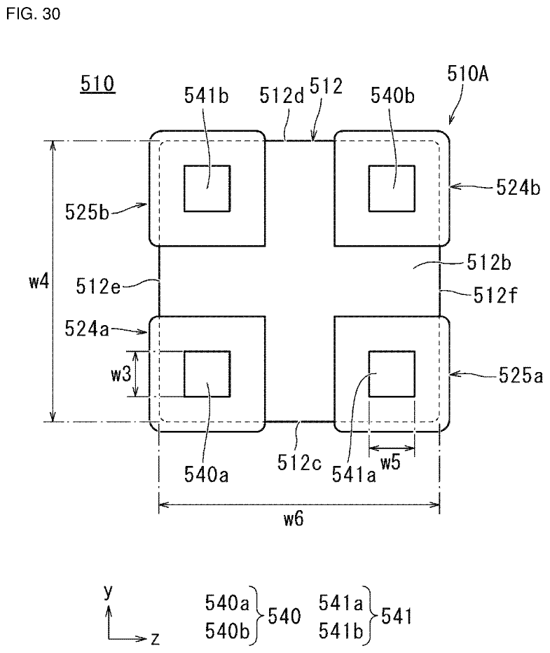

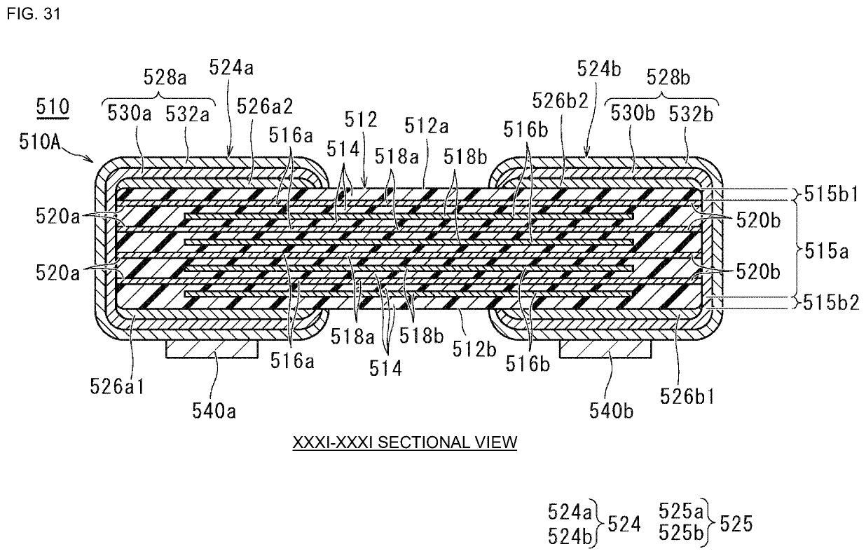

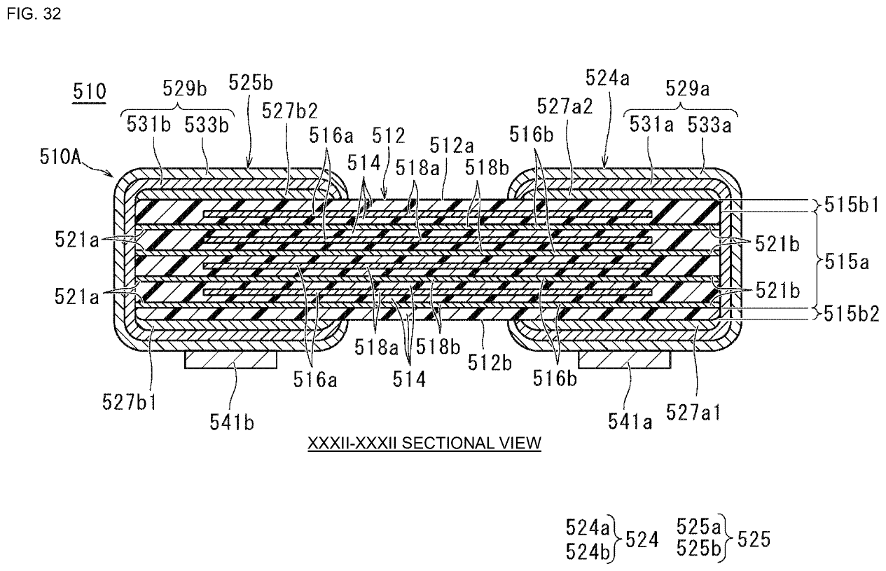

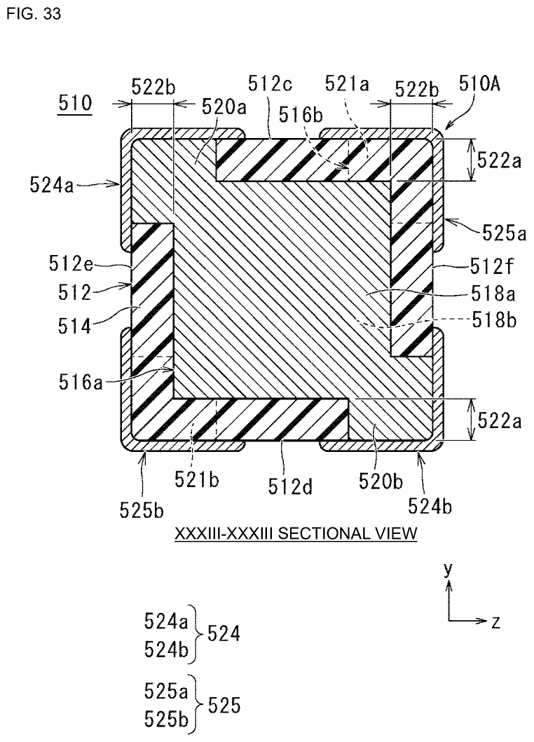

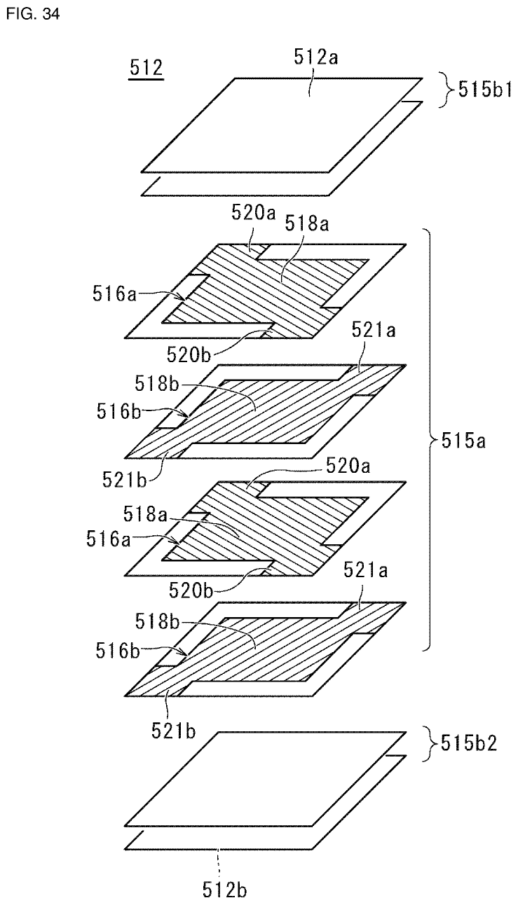

FIG. 28 illustrates a perspective view of an example of the multilayer ceramic electronic component according to the second example embodiment of the present invention. FIG. 29 illustrates a front view of an example of the multilayer ceramic electronic component according to the second example embodiment of the present invention. FIG. 30 illustrates a bottom view of an example of the multilayer ceramic electronic component according to the second example embodiment of the present invention. FIG. 31 illustrates a sectional view taken along line XXXI-XXXI in FIG. 28. FIG. 32 illustrates a sectional view taken along line XXXII-XXXII in FIG. 28. FIG. 33 illustrates a sectional view taken along line XXXIII-XXXIII in FIG. 28. FIG. 34 illustrates an exploded perspective view of a multilayer body illustrated in FIG. 28.

The multilayer ceramic capacitor 510A includes a multilayer body 512 and outer electrodes 524 and 525.

The multilayer body 512 includes multiple dielectric layers 514 and multiple inner electrode layers 516. The multilayer body 512 includes a first main surface 512a and a second main surface 512b that face away from each other in the height direction x, a first side surface 512c and a second side surface 512d that face away from each other in the length direction z perpendicular to the height direction x, a third side surface 512e and a fourth side surface 512f that face away from each other in the width direction y perpendicular to the height direction x and the width direction y. The first main surface 512a and the second main surface 512b extend in the width direction y and the length direction z. The first side surface 512c and the second side surface 512d extend in the height direction x and the width direction y. The third side surface 512e and the fourth side surface 512f extend in the height direction x and the length direction y. Accordingly, the height direction x extends between the first main surface 512a and the second main surface 512b, the width direction y extends between the first side surface 512c and the second side surface 512d, and the length direction z extends between the third side surface 512e and the fourth side surface 512f.

Corner portions and ridge portions of the multilayer body 512 are preferably rounded. The corner portions are portions at which three surfaces of the multilayer body 512 intersect, and the ridge portions are portions at which two surfaces of the multilayer body 512 intersect.

As illustrated in FIG. 31 and FIG. 32, the multilayer body 512 includes an effective layer portion 515a at which the multiple inner electrode layers 516 face each other in the height direction x extending between the first main surface 512a and the second main surface 512b, a first outer layer portion 515b1 that includes multiple dielectric layers 514 that are located between the inner electrode layer 516 nearest to the first main surface 512a and the first main surface 512a, and a second outer layer portion 515b2 that includes multiple dielectric layers 514 that are located between the inner electrode layer 516 nearest to the second main surface 512b and the second main surface 512b.

The first outer layer portion 515b1 is located near the first main surface 512a of the multilayer body 512 and is an aggregate of multiple dielectric layers 514 located between the first main surface 512a and the inner electrode layer 516 nearest to the first main surface 512a.

The second outer layer portion 515b2 is located near the second main surface 512b of the multilayer body 512 and is an aggregate of multiple dielectric layers 514 located between the second main surface 512b and the inner electrode layer 516 nearest to the second main surface 512b.

A region that is sandwiched between the first outer layer portion 515b1 and the second outer layer portion 515b2 corresponds to the effective layer portion 515a. The thicknesses of the first outer layer portion 515b1 and the second outer layer portion 515b2 are preferably no less than about 3 μm and no more than about 15 μm, for example. A region that is sandwiched between the outer layer portions 515b1 and 515b2 corresponds to an effective layer portion 515a. That is, the effective layer portion 515a corresponds to a region in which the inner electrode layers 516 are stacked.

For example, the dielectric layers 514 can include a dielectric material. The dielectric material can be dielectric ceramic that includes BaTiO₃, CaTiO₃, SrTiO₃, or CaZnO₃ as a main component. A material acquired by adding a sub-component such as an Mn compound, an Fe compound, a Cr compound, a Co compound, or an Ni compound to the main component may be used.

The number of the dielectric layers 514 is not particularly limited but is preferably no less than 5 and no more than 2000 with the first outer layer portion 515b1 and the second outer layer portion 515b2 included. The thicknesses of the dielectric layers 514 are preferably no less than about 0.30 μm and no more than about 5.0 μm, for example.

As illustrated in FIG. 31 to FIG. 34, the inner electrode layers 516 include multiple first inner electrode layers 516a and multiple second inner electrode layers 516b. The first inner electrode layers 516a and the second inner electrode layers 516b are stacked in turn with dielectric layers 514 interposed therebetween.

The first inner electrode layers 516a are disposed on surfaces of the dielectric layers 514. The first inner electrode layers 516a include first facing electrode portions 518a that face the first main surface 512a and the second main surface 512b and that face the second inner electrode layers 516b, and are stacked in a direction extending between the first main surface 512a and the second main surface 512b.

The second inner electrode layers 516b are disposed on surfaces of dielectric layers 514 that differ from dielectric layers 514 on which the first inner electrode layers 516a are disposed. The second inner electrode layers 516b include second facing electrode portions 518b that face the first main surface 512a and the second main surface 512b, and are stacked in the direction extending between the first main surface 512a and the second main surface 512b.

As illustrated in FIG. 31 to FIG. 34, the first inner electrode layers 516a extend to the first side surface 512c and the third side surface 512e of the multilayer body 512 by using first extension electrode portions 520a and extend to the second side surface 512d and the fourth side surface 512f of the multilayer body 512 by using second extension electrode portions 520b. The widths of the first extension electrode portions 520a that extend to the first side surface 512c may be substantially equal to the widths of the first extension electrode portions 520a that extend to the third side surface 512e, and the widths of the second extension electrode portions 520b that extend to the second side surface 512d may be substantially equal to the widths of the second extension electrode portions 520b that extend to the fourth side surface 512f. That is, the first extension electrode portions 520a extend to the third side surface 512e of the multilayer body 512, and the second extension electrode portions 520b extend to the fourth side surface 512f of the multilayer body 512.

The second inner electrode layers 516b extend to the first side surface 512c and the fourth side surface 512f of the multilayer body 512 by using third extension electrode portions 521a and extend to the second side surface 512d and the third side surface 512e of the multilayer body 512 by using fourth extension electrode portions 521b. The widths of the third extension electrode portions 521a that extend to the first side surface 512c may be substantially equal to the widths of the third extension electrode portions 521a that extend to the fourth side surface 512f, and the widths of the fourth extension electrode portions 521b that extend to the second side surface 512d may be substantially equal to the widths of the fourth extension electrode portions 521b that extend to the third side surface 512e. That is, the third extension electrode portions 521a extend to the fourth side surface 512f of the multilayer body 512, and the fourth extension electrode portions 521b extend to the second side surface 512d of the multilayer body 512.

When the multilayer ceramic capacitor 510A is viewed in the stacking direction, a straight line that connects the first extension electrode portions 520a and the second extension electrode portions 520b of the first inner electrode layers 516a to each other preferably intersects with a straight line that connects the third extension electrode portions 521a and the fourth extension electrode portions 521b of the second inner electrode layers 516b to each other.

As for the side surfaces 512c, 512d, 512e, and 512f of the multilayer body 512, the first extension electrode portions 520a of the first inner electrode layers 516a and the fourth extension electrode portions 521b of the second inner electrode layers 516b preferably extend to opposite positions, and the second extension electrode portions 520b of the first inner electrode layers 516a and the third extension electrode portions 521a of the second inner electrode layers 516b preferably extend to opposite positions.

For example, the material of the inner electrode layers 516 can include metal such as Ni, Cu, Ag, Pd, or Au, or an alloy that includes one kind of these metals such as Ag—Pd alloy. The inner electrode layers 516 may further include dielectric particles that have the same composition as the ceramic that is include in the dielectric layers 514.

The first inner electrode layers 516a and the second inner electrode layers 516b may include Sn. The first inner electrode layers 516a and the second inner electrode layers 516b that include Sn enable an electric field to be prevented from concentrating on the interfaces between the first inner electrode layers 516a and the dielectric layers 514 and between the second inner electrode layers 516b and the dielectric layers 514, and this leads to an improvement in the high-temperature load reliability. Even when only the inner electrode layers 516 of the first inner electrode layers 516a or the second inner electrode layers 516b include Sn, effects can be sufficiently exerted.

The number of the inner electrode layers 516 that are stacked is preferably no less than 20 and no more than 80, for example. The average thickness of the inner electrode layers 516 is preferably no less than about 0.2 μm and no more than about 2.0 μm, for example.

As for the multilayer body 512, as illustrated in FIG. 33, side portions (“L gaps”) 522b of the multilayer body 512 are located between ends of the first facing electrode portions 518a in the length direction z and the third side surface 512e and between ends of the second facing electrode portions 518b in the length direction z and the fourth side surface 512f.

As for the multilayer body 512, as illustrated in FIG. 33, side portions (“W gaps”) 522a of the multilayer body 512 are located between ends of the first facing electrode portions 518a in the width direction y and the first side surface 512c and between ends of the second facing electrode portions 518b in the width direction y and the second side surface 512d.

As illustrated in FIG. 28 to FIG. 33, the outer electrodes 524 and 525 are disposed on the multilayer body 512.

The outer electrodes 524 include main surface electrodes 526 and plating layers 528 that cover the main surface electrodes 526. The outer electrodes 525 include main surface electrodes 527 and plating layers 529 that cover the main surface electrodes 527.

The outer electrodes 524 include a first outer electrode 524a and a second outer electrode 524b.

The first outer electrode 524a covers the first extension electrode portions 520a along the first side surface 512c and the third side surface 512e and covers portions of the first main surface 512a and the second main surface 512b. The first outer electrode 524a is electrically connected to the first extension electrode portions 520a of the first inner electrode layers 516a.

The second outer electrode 524b covers the second extension electrode portions 520b along the second side surface 512d and the fourth side surface 512f and covers portions of the first main surface 512a and the second main surface 512b. The second outer electrode 524b is electrically connected to the second extension electrode portions 520b of the first inner electrode layers 516a.

The outer electrodes 525 include a third outer electrode 525a and a fourth outer electrode 525b.

The third outer electrode 525a covers the third extension electrode portions 521a along the first side surface 512c and the fourth side surface 512f and covers portions of the first main surface 512a and the second main surface 512b. The third outer electrode 525a is electrically connected to the third extension electrode portions 521a of the second inner electrode layers 516b.

The fourth outer electrode 525b covers the fourth extension electrode portions 521b along the second side surface 512d and the third side surface 512e and covers portions of the first main surface 512a and the second main surface 512b. The fourth outer electrode 525b is electrically connected to the fourth extension electrode portions 521b of the second inner electrode layers 516b.

In the multilayer body 512, the first facing electrode portions 518a of the first inner electrode layers 516a and the second facing electrode portions 518b of the second inner electrode layers 516b face each other with the dielectric layers 514 interposed therebetween, and consequently, electrostatic capacitance is formed. For this reason, the electrostatic capacitance can be acquired between the first outer electrode 524a and the second outer electrode 524b to which the first inner electrode layers 516a are connected and between the third outer electrode 525a and the fourth outer electrode 525b to which the second inner electrode layers 516b are connected, and the capacitor characteristics are exhibited.

The main surface electrodes 526 include a first main surface electrode 526a1, a second main surface electrode 526b1, a third main surface electrode 526a2, and a fourth main surface electrode 526b2. The first main surface electrode 526a1, the second main surface electrode 526b1, the third main surface electrode 526a2, and the fourth main surface electrode 526b2 are formed by using thin film layers that include multiple thin film electrodes in order to improve the performance.

The first main surface electrode 526a1 covers a portion of the second main surface 512b at a corner portion at which the second main surface 512b, the first side surface 512c, and the third side surface 512e intersect. The second main surface electrode 526b1 covers a portion of the second main surface 512b at a corner portion at which the second main surface 512b, the second side surface 512d, and the fourth side surface 512f intersect. The third main surface electrode 526a2 covers a portion of the first main surface 512a at a corner portion at which the first main surface 512a, the first side surface 512c, and the third side surface 512e intersect. The fourth main surface electrode 526b2 covers a portion of the first main surface 512a at a corner portion at which the first main surface 512a, the second side surface 512d, and the fourth side surface 512f intersect.

The main surface electrodes 527 include a fifth main surface electrode 527a1, a sixth main surface electrode 527b1, a seventh main surface electrode 527a2, and an eighth main surface electrode 527b2. The fifth main surface electrode 527a1, the sixth main surface electrode 527b1, the seventh main surface electrode 527a2, and the eighth main surface electrode 527b2 are formed by using thin film layers that include multiple thin film electrodes in order to improve the performance.

The fifth main surface electrode 527a1 covers a portion of the second main surface 512b at a corner portion at which the second main surface 512b, the first side surface 512c, and the fourth side surface 512f intersect. The sixth main surface electrode 527b1 covers a portion of the second main surface 512b at a corner portion at which the second main surface 512b, the second side surface 512d, and the third side surface 512e intersect. The seventh main surface electrode 527a2 covers a portion of the first main surface 512a at a corner portion at which the first main surface 512a, the first side surface 512c, and the fourth side surface 512f intersect. The eighth main surface electrode 527b2 covers a portion of the first main surface 512a at a corner portion at which the second main surface 512b, the second side surface 512d, and the third side surface 512e intersect.

The main surface electrodes 526 and 527 that are formed by using thin film layers are preferably formed by using a thin film forming method such as the sputtering method or the vapor deposition method. In particular, the main surface electrodes 526 and 527 that are formed by using thin film layers are preferably sputtering electrodes that are formed by using the sputtering method. The electrodes that are formed by using the sputtering method will now be described.

In the case where the main surface electrodes 526 and 527 are formed by using sputtering electrodes, the sputtering electrodes are preferably formed directly on a portion of the first main surface 512a and a portion of the second main surface 512b of the multilayer body 512.

For example, the main surface electrodes 526 and 527 may include metal such as Ni, Cu, Ag, Pd, Ag—Pd alloy, or Au. In this case, the main surface electrodes 526 and 527 preferably include the same dielectric material as the dielectric ceramic that is include in the dielectric layers 514 as a common material. When being fired, the main surface electrodes 526 and 527 that include the common material can shrink in a manner close to a manner in which the multilayer body 512 shrinks, and the main surface electrodes 526 and 527 can be prevented from being separated from the multilayer body 512.

The plating layers 528 include a first plating layer 528a and a second plating layer 528b. The first plating layer 528a covers the first main surface electrode 526a1 and the third main surface electrode 526a2. The second plating layer 528b covers the second main surface electrode 526b1 and the fourth main surface electrode 526b2.

The plating layers 529 include a third plating layer 529a and a fourth plating layer 529b. The third plating layer 529a covers the fifth main surface electrode 527a1 and the seventh main surface electrode 527a2. The fourth plating layer 529b covers the sixth main surface electrode 527b1 and the eighth main surface electrode 527b2.

The plating layers 528 and the plating layers 529 may include multiple layers. The plating layers 528 preferably include lower plating layers 530 that cover the main surface electrodes 526 and upper plating layers 532 that cover the lower plating layers 530. Similarly, the plating layers 529 include lower plating layers 531 that cover the main surface electrodes 527 and upper plating layers 533 that cover the lower plating layers 531. For example, the upper plating layers 532 of the plating layers 528 include at least one of Ni, Sn, Cu, Ag, Pd, Ag—Pd alloy, or Au. Similarly, for example, the upper plating layers 533 of the plating layers 529 include at least one of Ni, Sn, Cu, Ag, Pd, Ag—Pd alloy, or Au.

The lower plating layers 530 include a first lower plating layer 530a and a second lower plating layer 530b.

The first lower plating layer 530a is disposed on the first side surface 512c and the third side surface 512e of the multilayer body 512 on which no main surface electrode is disposed and covers the first main surface electrode 526a1 that is disposed on the second main surface 512b and the third main surface electrode 526a2 that is disposed on the first main surface 512a.

The second lower plating layer 530b is disposed on the second side surface 512d and the fourth side surface 512f of the multilayer body 512 on which no main surface electrode is disposed and covers the second main surface electrode 526b1 that is disposed on the second main surface 512b and the fourth main surface electrode 526b2 that is disposed on the first main surface 512a.

The lower plating layers 531 include a third lower plating layer 531a and a fourth lower plating layer 531b.

The third lower plating layer 531a is disposed on the first side surface 512c and the fourth side surface 512f of the multilayer body 512 on which no main surface electrode is disposed and covers the fifth main surface electrode 527a1 that is disposed on the second main surface 512b and the seventh main surface electrode 527a2 that is disposed on the first main surface 512a.

The fourth lower plating layer 531b is disposed on the second side surface 512d and the third side surface 512e of the multilayer body 512 on which no main surface electrode is disposed and covers the sixth main surface electrode 527b1 that is disposed on the second main surface 512b and the eighth main surface electrode 527b2 that is disposed on the first main surface 512a.

The thickness of the lower plating layers 530 and 531 per layer is preferably no less than about 2 μm and no more than about 11 μm, for example.

The upper plating layers 532 include a first upper plating layer 532a and a second upper plating layer 532b.

The first upper plating layer 532a covers the first lower plating layer 530a. Specifically, the first upper plating layer 532a is preferably disposed on surfaces of the first lower plating layer 530a along the first side surface 512c and the third side surface 512e so as to extend to the first main surface 512a and the second main surface 512b along the surfaces of the first lower plating layer 530a.

The second upper plating layer 532b covers the second lower plating layer 530b. Specifically, the second upper plating layer 532b is preferably disposed on surfaces of the second lower plating layer 530b along the second side surface 512d and the fourth side surface 512f so as to extend to the first main surface 512a and the second main surface 512b along the surfaces of the second lower plating layer 530b.

The upper plating layers 533 include a third upper plating layer 533a and a fourth upper plating layer 533b.

The third upper plating layer 533a covers the third lower plating layer 531a. Specifically, the third upper plating layer 533a is preferably disposed on surfaces of the third lower plating layer 531a along the first side surface 512c and the fourth side surface 512f so as to extend to the first main surface 512a and the second main surface 512b along the surfaces of the third lower plating layer 531a.

The fourth upper plating layer 533b covers the fourth lower plating layer 531b. Specifically, the fourth upper plating layer 533b is preferably disposed on surfaces of the fourth lower plating layer 531b along the second side surface 512d and the third side surface 512e so as to extend to the first main surface 512a and the second main surface 512b along the surfaces of the fourth lower plating layer 531b.

As for a two-layer structure according to the present example embodiment, the lower plating layers 530 and 531 are Ni plating layers, and the upper plating layers 532 and 533 are Sn plating layers. When the lower plating layers 530 and 531 are Ni plating layers, the main surface electrodes 526 and 527 can be prevented from being eroded by solder when the multilayer ceramic electronic component 510 is mounted on the mounting substrate. When the upper plating layers 532 and 533 are Sn plating layers, the wettability of the solder when the multilayer ceramic electronic component 510 is mounted on the mounting substrate can be improved, and the multilayer ceramic electronic component 510 can be easily mounted.

The thickness of the upper plating layers 532 and 533 per layer is preferably no less than about 2 μm and no more than about 11 μm, for example.

The bumps 540 that are included in the multilayer ceramic electronic component 510 include a first bump 540a and a second bump 540b. The bumps 541 that are included in the multilayer ceramic electronic component 510 include a third bump 541a and a fourth bump 541b.

The first bump 540a is disposed on a surface of the first outer electrode 524a near the second main surface 512b. The second bump 540b is disposed on a surface of the second outer electrode 524b near the second main surface 512b.

The third bump 541a is disposed on a surface of the third outer electrode 525a near the second main surface 512b. The fourth bump 541b is disposed on a surface of the fourth outer electrode 525b near the second main surface 512b.

As for a multilayer ceramic electronic component 510 according to an example embodiment of the present invention, the second main surface 512b serves as the mounting surface to face the mounting substrate.

A main component in the bumps 540 and 541 is an intermetallic compound that includes at least one kind of high-melting-point metal selected from Cu or Ni and a low-melting-point metal of Sn. In particular, the intermetallic compound is preferably generated by a reaction between Sn and Cu—Ni alloy. The intermetallic compound has advantages of high reaction speed and little deformation when being generated. The high-melting-point metal that is include in the intermetallic compound may further include Ag.

The condition of, for example, about 0.5<t1/t2<about 0.75 is satisfied, where t1 is the thickness of each of the first bump 540a, the second bump 540b, the third bump 541a, and the fourth bump 541b in the height direction x, and t2 is the thickness of the multilayer body 512 in the height direction x.

For example, the thickness t1 of each of the first bump 540a, the second bump 540b, the third bump 541a, and the fourth bump 541b in the height direction x and the thickness t2 of the multilayer body 512 in the height direction x are measured by observing the appearance by using the digital microscope (KEYENCE CORPORATION: VHX-8000) with the magnification being no less than 500 and no more than 2000.

A condition of, for example, about ⅕<w3/w4<about ¼ is preferably satisfied, where w3 is the dimension of each of the first bump 540a, the second bump 540b, the third bump 541a, and the fourth bump 541b in the width direction y, and w4 is the dimension of the multilayer body 512 in the width direction y.

A condition of, for example, about ⅕<w5/w6<about ¼ is preferably satisfied, where w5 is the dimension of each of the first bump 540a, the second bump 540b, the third bump 541a, and the fourth bump 541b in the length direction z, and w6 is the dimension of the multilayer body 512 in the length direction z.

For example, the dimension w3 of each of the first bump 540a, the second bump 540b, the third bump 541a, and the fourth bump 541b in the width direction y and the thickness w4 of the multilayer body 512 in the width direction y are measured by observing the appearance by using the digital microscope (KEYENCE CORPORATION: VHX-8000) with the magnification being no less than 500 and no more than 2000. Similarly, for example, the dimension w5 of each of the first bump 540a, the second bump 540b, the third bump 541a, and the fourth bump 541b in the length direction z and the thickness w6 of the multilayer body 512 in the length direction z are measured by observing the appearance by using the digital microscope (KEYENCE CORPORATION: VHX-8000) with the magnification being no less than 500 and no more than 2000.

The Vickers hardness (HV) of the first bump 540a, the second bump 540b, the third bump 541a, and the fourth bump 541b is preferably no less than 30 and no more than 40.

The dimension of the multilayer ceramic capacitor 510A that includes the multilayer body 512 and the outer electrodes 524 and 525 in the length direction z is referred to as an L dimension, the dimension of the multilayer ceramic capacitor 510A that includes the multilayer body 12 and the outer electrodes 524 and 525 in the height direction x is referred to as a T dimension, and the dimension of the multilayer ceramic capacitor 510A that includes the multilayer body 12 and the outer electrodes 524 and 525 in the width direction y is referred to as a W dimension. As for the dimensions of the multilayer ceramic capacitor 510A, the L dimension in the length direction z is preferably no less than about 0.1 mm and no more than about 6.0 mm, and the W dimension in the width direction y is preferably no less than about 0.1 mm and no more than about 6.0 mm, for example. Here, about 7/10≤L/W≤about 10/7 is preferably satisfied, for example. In this manner, the multilayer ceramic capacitor is formed into a substantially quasi-tetragonal shape, and accordingly, the degree of freedom of implementation increases.

As for the multilayer ceramic electronic component 510 illustrated in FIG. 27, the multilayer ceramic capacitor 510A includes the first bump 540a that is disposed on the surface of the first outer electrode 524a near the second main surface 12b, the second bump 540b that is disposed on the surface of the second outer electrode 524b near the second main surface 12b, and the third bump 541a that is disposed on the surface of the third outer electrode 525a near the second main surface 512b, and the fourth bump 541b that is disposed on a surface of the fourth outer electrode 525b near the second main surface 512b, and the condition of about 0.5<t1/t2<about 0.75 is satisfied, for example, where t1 is the thickness of each of the first bump 540a, the second bump 540b, the third bump 541a, and the fourth bump 541b in the height direction x, and t2 is the thickness of the multilayer body 12 in the height direction x. Accordingly, an impact on the multilayer ceramic electronic component 510 due to the mounter nozzle is transmitted to the bumps 540 particularly when the multilayer ceramic electronic component 510 that is thin is mounted on the mounting substrate. This enables the multilayer body to be prevented from being damaged due to stress caused by the impact and concentrated on an edge portion of an outer electrode that is located near a main surface of the multilayer ceramic capacitor.

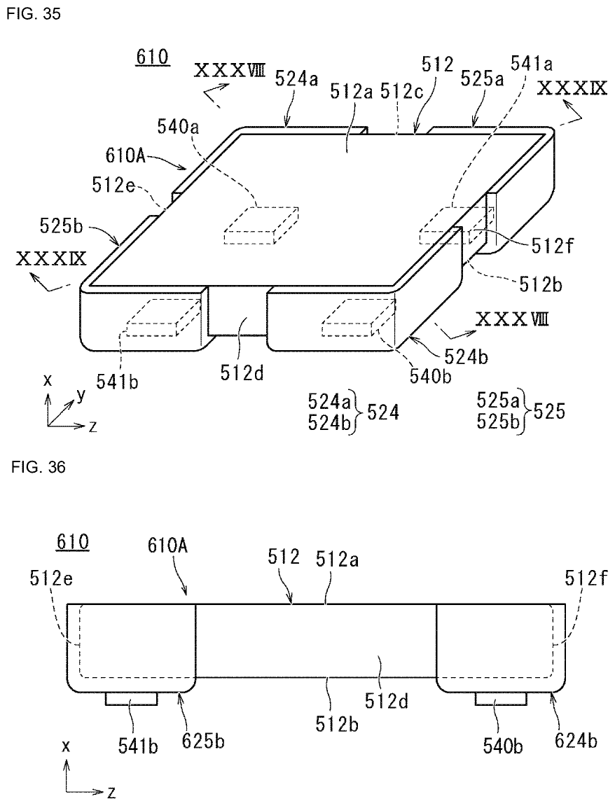

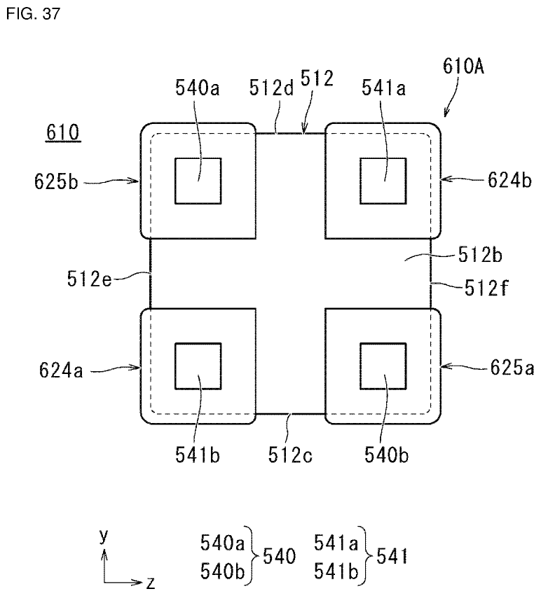

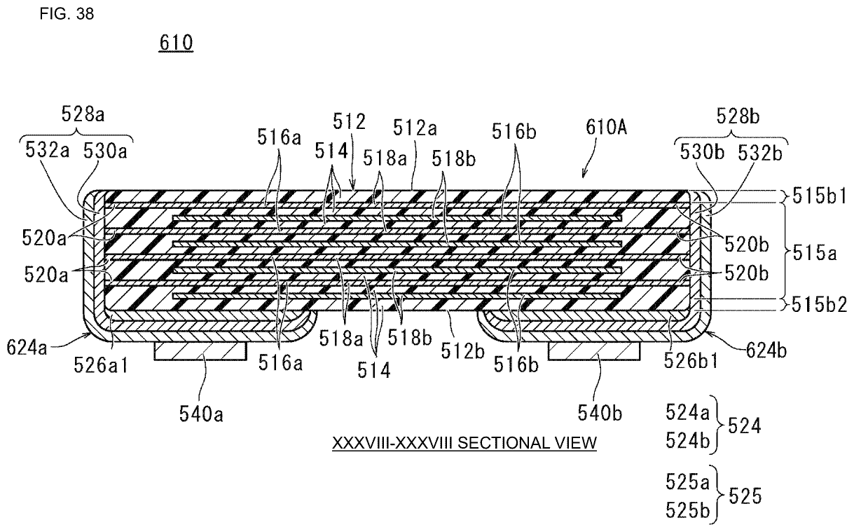

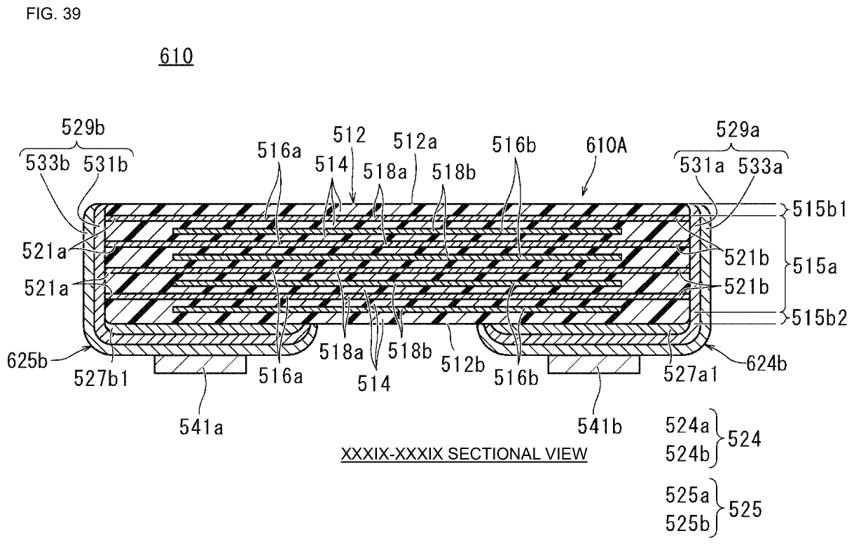

A multilayer ceramic capacitor according to a modification to the second example embodiment of the present invention will now be described. FIG. 35 illustrates a perspective view of an example of a multilayer ceramic electronic component according to a first modification to the second example embodiment of the present invention. FIG. 36 illustrates a front view of an example of a multilayer ceramic electronic component according to a modification to the second example embodiment of the present invention. FIG. 37 illustrates a bottom view of a multilayer ceramic capacitor that is an example of the multilayer ceramic electronic component according to a modification to the second example embodiment of the present invention. FIG. 38 illustrates a sectional view taken along line XXXVIII-XXXVIII in FIG. 35. FIG. 39 illustrates a sectional view taken along line XXXIX-XXXIX in FIG. 35.

Portions of a multilayer ceramic electronic component 510 illustrated in FIG. 35 like to those of the multilayer ceramic electronic component 610 illustrated in FIG. 28 to FIG. 34 are designated by using like reference signs, and the description thereof is omitted.

The multilayer ceramic electronic component 610 according to the second modification includes a multilayer ceramic capacitor 610A and bumps 540.

The multilayer ceramic capacitor 610A includes the multilayer body 512 that has a rectangular cuboid shape and outer electrodes 624 and 625.

The outer electrodes 624 include the main surface electrodes 526 and the plating layers 528 that cover the main surface electrodes 526. The outer electrodes 625 include the main surface electrodes 527 and the plating layers 529 that cover the main surface electrodes 527.

The outer electrodes 624a include a first outer electrode 624 and a second outer electrode 624b.

The first outer electrode 624a covers the first extension electrode portions 520a along the first side surface 512c and the third side surface 512e and covers a portion of the second main surface 512b. The first outer electrode 624a is electrically connected to the first extension electrode portions 520a of the first inner electrode layers 516a.

The second outer electrode 624b covers the second extension electrode portions 520b along the second side surface 512d and the fourth side surface 512f and covers a portion of the second main surface 512b. The second outer electrode 624b is electrically connected to the second extension electrode portions 520b of the first inner electrode layers 516a.

The outer electrodes 625 include a third outer electrode 625a and a fourth outer electrode 625b.

The third outer electrode 625a covers the third extension electrode portions 521a along the first side surface 512c and the fourth side surface 512f and covers a portion of the second main surface 512b. The third outer electrode 625a is electrically connected to the third extension electrode portions 521a of the second inner electrode layers 516b.

The fourth outer electrode 625b covers the fourth extension electrode portions 521b along the second side surface 512d and the third side surface 512e and covers a portion of the second main surface 512b. The fourth outer electrode 625b is electrically connected to the fourth extension electrode portions 521b of the second inner electrode layers 516b.

The plating layers 528 include the first plating layer 528a and the second plating layer 528b. The first plating layer 528a covers the first main surface electrode 526a1. The second plating layer 528b covers the second main surface electrode 526b1.

The plating layers 529 include the third plating layer 529a and the fourth plating layer 529b. The third plating layer 529a covers the fifth main surface electrode 527a1. The fourth plating layer 529b covers the sixth main surface electrode 527b1. The structures of the plating layers 530 and 531 of the multilayer ceramic capacitor 610A according to the present modification are the same as the structures of the plating layers 530 and 531 of the multilayer ceramic capacitor 510A.

The bumps 540 that are included in the multilayer ceramic electronic component 610 include the first bump 540a and the second bump 540b. The bumps 541 that are included in the multilayer ceramic electronic component 510 include the third bump 541a and the fourth bump 541b.

The first bump 540a is disposed on the surface of the first outer electrode 524a near the second main surface 512b. The second bump 540b is disposed on the surface of the second outer electrode 524b near the second main surface 512b.

The third bump 541a is disposed on the surface of the third outer electrode 525a near the second main surface 512b. The fourth bump 541b is disposed on a surface of the fourth outer electrode 525b near the second main surface 512b.

The multilayer ceramic electronic component 610 illustrated in FIG. 35 exerts the same effects as the multilayer ceramic electronic component 510 described above and exerts the following effects. That is, the outer electrodes 624 and 625 are not formed on the first main surface 12a. Accordingly, the thickness of the multilayer body 512 can be increased due to the absence of thickness there, the strength of the multilayer ceramic capacitor 610A can be improved, and the electrostatic capacitance per volume can be improved. Solder can be prevented from getting wet on an upper surface (the first main surface 512a) of the multilayer ceramic capacitor 610A during mounting, and accordingly, the thickness of the multilayer body 512 can be further increased.

A non-limiting example of a method of manufacturing the multilayer ceramic electronic component 510 according to the second example embodiment will now be described. A method of manufacturing the multilayer ceramic capacitor 510A of the multilayer ceramic electronic component 510 will be first described.

Ceramic green sheets and conductive paste for inner electrodes are prepared. The ceramic green sheets and the conductive paste for inner electrodes include a binder (such as a known organic binder) and a solvent (such as an organic solvent).

Subsequently, the conductive paste for inner electrodes is printed on ceramic green sheets with predetermined patterns by, for example, screen printing or gravure printing, and inner electrode patterns illustrated in FIG. 33 are formed. Specifically, conductive material paste is applied to the ceramic green sheets by using, for example, the printing method described above, and consequently, conductive paste layers are formed. An example of the conductive material paste is a mixture of an organic binder and an organic solvent that are added into metal powder. As for the ceramic green sheets, ceramic green sheets for an outer layer on which no inner electrode pattern is printed are manufactured.

A multilayer sheet is manufactured by using the ceramic green sheets having the inner electrode patterns. That is, a predetermined number of ceramic green sheets for an outer layer on which no inner electrode pattern is formed are stacked, ceramic green sheets on which inner electrode patterns corresponding to the first inner electrode layers 516a are formed and ceramic green sheets on which inner electrode patterns corresponding to the second inner electrode layers 516b are formed are stacked thereon in turn, and the predetermined number of ceramic green sheets on which no inner electrode pattern is formed are stacked thereon. Consequently, the multilayer sheet is manufactured.

The multilayer sheet is pressed in the stacking direction by, for example, isostatic press, and a multilayer block is manufactured.

Subsequently, the multilayer block is cut to a predetermined size, and multilayer chips are manufactured. At this time, corner portions and ridge portions of the multilayer chips may be rounded by, for example, barrel polishing.

Subsequently, the multilayer chips are fired, and consequently, the multilayer body 512 is manufactured. The firing temperature is preferably no less than about 900° C. and no more than about 1300° C., for example, although this depends on ceramic and an inner electrode material.

At this time, the first extension electrode portions 520a of the first inner electrode layers 516a are exposed from the first side surface 512c and the third side surface 512e of the multilayer body 512, and the third extension electrode portions 521a of the second inner electrode layers 516b are exposed from the first side surface 512c and the fourth side surface 512f of the multilayer body 512. The second extension electrode portions 520b of the first inner electrode layers 516a are exposed from the second side surface 512d and the fourth side surface 512f of the multilayer body 512, and the fourth extension electrode portions 521b of the second inner electrode layers 516b are exposed from the second side surface 512d and the third side surface 512e of the multilayer body 512.

Subsequently, the main surface electrodes 526 and 527 that include thin film electrode layers are formed on portions of the first main surface 512a of the multilayer body 512 and portions of the second main surface 512b. The main surface electrodes 526 and 527 that are thin film layers can be formed by using, for example, the sputtering method. In other words, the main surface electrodes that are thin film layers include sputtering electrodes. The sputtering electrodes can be formed by using metal that includes at least one of, for example, Ni, Cr, Cu, or Ti.

In the case where the outer electrodes 624 and 625 are formed such that no outer electrode is disposed on the first main surface 512a as in the multilayer ceramic capacitor 610A, the main surface electrodes 526 and 527 are not formed on the first main surface 512a.

Subsequently, a Cu plating layer that is the first lower plating layer 530a is formed so as to cover the first main surface electrode 526a1 that is disposed on the first side surface 512c and the third side surface 512e of the multilayer body 512 on which no main surface electrode is disposed and that is disposed on the second main surface 512b, and the third main surface electrode 526a2 that is disposed on the first main surface 512a, and a Cu plating layer that is the second lower plating layer 530b is formed so as to cover the second main surface electrode 526b1 that is disposed on the second side surface 512d and the fourth side surface 512f of the multilayer body 512 on which no main surface electrode is disposed and that is disposed on the second main surface 512b, and the fourth main surface electrode 526b2 that is disposed on the first main surface 512a. A Cu plating layer that is the third lower plating layer 531a is formed so as to cover the fifth main surface electrode 527a1 that is disposed on the first side surface 512c and the fourth side surface 512f of the multilayer body 512 on which no main surface electrode is disposed and that is disposed on the second main surface 512b, and the seventh main surface electrode 527a2 that is disposed on the first main surface 512a, and a Cu plating layer that is the fourth lower plating layer 531b is formed so as to cover the sixth main surface electrode 527b1 that is disposed on the second side surface 512d and the third side surface 512e of the multilayer body 512 on which no main surface electrode is disposed and that is disposed on the second main surface 512b, and the eighth main surface electrode 527b2 that is disposed on the first main surface 512a. When the lower plating layers 530a, 530b, 531a, and 531b are formed, electrolytic plating is performed by using an electroplating bath that includes an additive or electroless plating due to a substitution reaction is performed.

Subsequently, the upper plating layers 532 are formed on surfaces of the lower plating layers 530, and the upper plating layers 533 are formed on surfaces of the lower plating layers 531. The upper plating layers 532 and 533 include at least one of, for example, Cu, Ni, Sn, Ag, Pd, Ag—Pd alloy, or Au, and include a single layer or multiple layers. The upper plating layers 532 and 533 are preferably formed such that an Ni plating layer and an Sn plating layer on the Ni plating layer are formed, and the two layers are formed. In this way, as illustrated in FIG. 27, the outer electrodes 524 and 525 are formed.

A method of forming the bumps 540 and 541 on the multilayer ceramic capacitor 510A in order to manufacture the multilayer ceramic electronic component 510 will now be described.

At least one kind of high-melting-point metal selected from Cu or Ni to be the material of the bumps 540 and 541 and metal material paste that includes Sn as low-melting-point metal are prepared. The metal material paste includes screen printing so as to have a desired pattern by using a squeegee with respect to the multilayer ceramic capacitor 510A that is aligned on a holding substrate. For this reason, for example, a masking jig is prepared, and the masking jig is disposed with respect to the multilayer ceramic capacitor 510A that is aligned on the holding substrate. For example, the masking jig includes a mask plate that has a rectangular shape in plan view. The masking plate has multiple through-holes that extend from a main surface thereof to another main surface. The through-holes have a rectangular shape in plan view. The size of the rectangular shape in plan view determines the sizes of the bumps 540 and 541. The metal material paste to be the first bump 540a is applied to a surface of the first outer electrode 524a of the multilayer ceramic capacitor 510A near the second main surface 512b, and the metal material paste to be the second bump 540b is applied to a surface of the second outer electrode 524b thereof near the second main surface 12b. Similarly, the metal material paste to be the third bump 541a is applied to a surface of the third outer electrode 525a of the multilayer ceramic capacitor 510A near the second main surface 512b, and the metal material paste to be the fourth bump 541b is applied to a surface of the fourth outer electrode 525b thereof near the second main surface 512b.

When the bumps 540 and 541 are formed, a method of applying the metal material paste can be an ink-jet printing method.

The multilayer ceramic electronic component 510 illustrated in FIG. 28 is manufactured in the above manner.

The example embodiments of the present invention are disclosed by being described above, but the present invention is not limited thereto. That is, the example embodiments and the modifications described above can be changed in various ways regarding, for example, mechanisms, shapes, materials, numerals, positions, or arrangement without departing from the technical ideas and features of the present invention, and these are included in the present invention.

Example embodiments of the present invention provide multilayer ceramic electronic components that can be effectively used particularly when the multilayer ceramic electronic components are mounted on mounting substrates by using a mounter.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer ceramic capacitor including:
a multilayer body that including multiple stacked dielectric layers, a first main surface and a second main surface facing away from each other in a height direction, a first side surface and a second side surface facing away from each other in a width direction perpendicular to the height direction, and a first end surface and a second end surface facing away from each other in a length direction perpendicular to the height direction and the width direction;
a first outer electrode located at least on the first end surface and the second main surface of the multilayer body; and
a second outer electrode located at least on the second end surface and the second main surface of the multilayer body; and
a bump on a surface of the first outer electrode and a surface of the second outer electrode at or adjacent to the second main surface of the multilayer body; wherein
a condition of about 0.5<t1/t2<about 0.75 is satisfied, where t1 is a thickness of the bump in the height direction, and t2 is a thickness of the multilayer body in the height direction.

2. The multilayer ceramic electronic component according to claim 1, wherein a Vickers hardness of the bump is not less than about 30 and no more than about 40.

3. The multilayer ceramic electronic component according to claim 1, wherein the bump is an intermetallic compound.

4. The multilayer ceramic electronic component according to claim 1, wherein a dimension of the multilayer body in the height direction is about 110 μm or less.

5. The multilayer ceramic electronic component according to claim 1, wherein the multilayer body includes end gaps.

6. The multilayer ceramic electronic component according to claim 1, wherein the multilayer body includes side gaps.

7. The multilayer ceramic electronic component according to claim 1, wherein the bump includes Cu or Ni or Sn.

8. The multilayer ceramic electronic component according to claim 1, wherein a thickness of the bump is about 20 μm and no more than about 30 μm.

9. The multilayer ceramic electronic component according to claim 1, wherein about 0.6<w1/w2<about 0.9 is satisfied, where w1 is a dimension of the bump in the width direction, and w2 is a dimension of the multilayer body in the width direction.

10. The multilayer ceramic electronic component according to claim 1, wherein
about ⅕<w3/w4<about ¼ is satisfied, where w3 is a dimension of the bump in the width direction, and w4 is a dimension of the multilayer body in the width direction; and
about ⅕<w5/w6<about ¼ is satisfied, where w5 is a dimension of the bump in the length direction, and w6 is a dimension of the multilayer body in the length direction.

11. A multilayer ceramic electronic component comprising:
a multilayer ceramic capacitor including:
a multilayer body including multiple stacked dielectric layers, a first main surface and a second main surface facing away from each other in a height direction, a first side surface and a second side surface facing away from each other in a width direction perpendicular to the height direction, and a third side surface and a fourth side surface facing away from each other in a length direction perpendicular to the height direction and the width direction; and
at least four outer electrodes located on two or more surfaces among six surfaces of the first main surface, the second main surface, the first side surface, the second side surface, the third side surface, and the fourth side surface of the multilayer body; and
a bump on surfaces of the at least four outer electrodes at or adjacent to the second main surface of the multilayer body; wherein
a condition of about 0.5<t1/t2<about 0.75 is satisfied, where t1 is a thickness of the bump in the height direction, and t2 is a thickness of the multilayer body in the height direction.

12. The multilayer ceramic electronic component according to claim 11, wherein a Vickers hardness of the bump is not less than about 30 and no more than about 40.

13. The multilayer ceramic electronic component according to claim 11, wherein the bump is an intermetallic compound.

14. The multilayer ceramic electronic component according to claim 11, wherein a dimension of the multilayer body in the height direction is about 110 μm or less.

15. The multilayer ceramic electronic component according to claim 11, wherein the multilayer body includes end gaps.

16. The multilayer ceramic electronic component according to claim 11, wherein the multilayer body includes side gaps.

17. The multilayer ceramic electronic component according to claim 11, wherein the bump includes Cu or Ni or Sn.

18. The multilayer ceramic electronic component according to claim 11, wherein a thickness of the bump is about 20 μm and no more than about 30 μm.

19. The multilayer ceramic electronic component according to claim 11, wherein about 0.6<w1/w2<about 0.9 is satisfied, where w1 is a dimension of the bump in the width direction, and w2 is a dimension of the multilayer body in the width direction.

20. The multilayer ceramic electronic component according to claim 11, wherein
about ⅕<w3/w4<about ¼ is satisfied, where w3 is a dimension of the bump in the width direction, and w4 is a dimension of the multilayer body in the width direction; and
about ⅕<w5/w6<about ¼ is satisfied, where w5 is a dimension of the bump in the length direction, and w6 is a dimension of the multilayer body in the length direction.
